(19) United States
(12) Patent Application Publication
(10) Pub. No.: US 2026/0296233 A1
(43) Pub. Date: Oct. 1, 2026

(54) SYSTEM AND METHOD OF GENERATING ADDITIONAL HEAT USING AN ON-BOARD CHARGER

(71) Applicant: Volvo Car Corporation, Göteborg (SE)

(72) Inventors: Joachim HÄRSJÖ, Göteborg (SE); Ulf NILSSON, Göteborg (SE)

(73) Assignee: Volvo Car Corporation, Göteborg (SE)

(21) Appl. No.: 19/095,445

(22) Filed: Mar. 31, 2025

(51) Int. Cl. B60L 53/22; B60L 1/02; B60L 53/10

(52) U.S. Cl. CPC B60L 53/22; B60L 1/02; B60L 53/11; B60L 2210/10; B60L 2240/662; B60L 2260/58

(57) ABSTRACT

Embodiments relate to a system and method for generating additional heat using an on-board charger. The system comprising the on-board charger and a processor operatively coupled to the on-board charger, wherein the processor is operable to: determine an amount of heat to be generated by the on-board charger, wherein the on-board charger is associated with a vehicle; configure one or more phase legs of the on-board charger to operate as a switch; and control each of the switches associated with the one or more phase legs to generate the determined amount of heat.

### TECHNICAL FIELD

This disclosure relates to the field of thermal management in vehicles. The disclosure is more particularly related to a system and method of generating additional heat using an on-board charger.

### BACKGROUND

Typically, electric vehicles (EVs) are designed to perform with very high efficiency, thereby restricting the amount of heat loss. To reduce heat loss, heat required for a specific use may be generated either by using dedicated components or by operating other components in a heat generation mode. However, having dedicated components increases cost and adds weight and volume. Further, using other components having a different main function to generate heat may include drawbacks such as generating a limited amount of heat, or the main function of the component may be compromised due to this added function. Currently, a traction inverter connected in the EV is used to generate heat apart from performing its main function. However, there is a limitation in the amount of heat it can produce. Further when used as a heat generator the torque availability from the traction inverter and the lifetime of the traction inverter poses a concern.

Therefore, there is a need for a system and method of generating additional heat using an on-board charger.

### SUMMARY

The following presents a summary to provide a basic understanding of one or more embodiments described herein. This summary is not intended to identify key or critical elements or delineate any scope of the different embodiments and/or any scope of the claims. The sole purpose of the summary is to present some concepts in a simplified form as a prelude to the more detailed description presented herein.

In an aspect the present disclosure relates to a system comprising: an on-board charger; and a processor operatively coupled to the on-board charger, wherein the processor is operable to: determine an amount of heat to be generated by the on-board charger, wherein the on-board charger is associated with a vehicle; configure one or more phase legs of the on-board charger to operate as a switch; and control each of the switches associated with the one or more phase legs to generate the determined amount of heat.

In another aspect the present disclosure relates to a method comprising: obtaining a heat requirement of a thermal system associated with a vehicle; determining an amount of heat to be generated by an on-board charger based on the heat requirement, wherein the on-board charger is associated with the vehicle; and configuring one or more phase legs of the on-board charger to operate as a switch to generate the determined amount of heat.

In yet another aspect the present disclosure relates to a non-transitory computer-readable medium having stored thereon instructions executable by a processor to perform operations comprising: obtaining a heat requirement of a thermal system associated with a vehicle; determining an amount of heat to be generated by an on-board charger based on the heat requirement, wherein the on-board charger is associated with the vehicle; and configuring one or more phase legs of the on-board charger to operate as a switch to generate the determined amount of heat.

### BRIEF DESCRIPTION OF THE FIGURES

FIG. 1 illustrates a block diagram of a system associated with a vehicle according to an embodiment.

FIG. 2 illustrates a block diagram of electronic components of the vehicle according to an embodiment.

FIG. 3 illustrates a block diagram of a thermal management system in the vehicle according to an embodiment.

FIG. 4 illustrates a functional block diagram of the on-board charger in the vehicle according to an embodiment.

FIG. 5A illustrates a circuit diagram of phase legs of the on-board charger according to an embodiment.

FIG. 5B illustrates a voltage versus current graph according to an embodiment.

FIG. 5C illustrates a gate driver circuit for providing V_{GE} according to an embodiment.

FIG. 5D illustrates an active gate driver circuit for providing V_{GE} according to an embodiment.

FIG. 6 illustrates an example block diagram for an Artificial Intelligence and Machine Learning (AI/ML) model used in a system for generating additional heat using an on-board charger according to an embodiment.

FIG. 7A illustrates a structure of the neural network/machine learning model with a feedback loop according to an embodiment.

FIG. 7B illustrates a structure of the neural network/machine learning model with reinforcement learning according to an embodiment.

FIG. 8 illustrates a flow chart describing a method of generating additional heat using an on-board charger according to an embodiment.

FIG. 9 illustrates a block diagram of the system implementing the method for generating additional heat using an on-board charger according to an embodiment.

FIG. 10 illustrates a block diagram of the method executed by the non-transitory computer-readable medium for generating additional heat using an on-board charger according to an embodiment.

FIG. 11A illustrates the block diagram of the cyber security module in view of the system and server according to an embodiment.

FIG. 11B illustrates an embodiment of the cyber security module according to an embodiment.

FIG. 11C illustrates another embodiment of the cyber security module according to an embodiment.

### DETAILED DESCRIPTION

### Definitions and General Techniques

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numeral in different figures denotes the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

No element, act, or instruction used herein should be construed as critical or essential unless explicitly described as such. Also, as used herein, the articles “a” and “an” are intended to include items, and may be used interchangeably with “one or more.” Furthermore, as used herein, the term “set” is intended to include items (e.g., related items, unrelated items, a combination of related items, and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

The terms “couple,” “coupled,” “couples,” “coupling,” and the like should be broadly understood and refer to connecting two or more elements mechanically and/or otherwise. Two or more electrical elements may be electrically coupled together but not be mechanically or otherwise coupled together. Coupling may be for any length of time, e.g., permanent, or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As used herein, the term “or” means an inclusive “or” rather than an exclusive “or.” That is, unless specified otherwise, or clear from context, “X uses A or B” means any of the natural inclusive permutations. That is, if X uses A; X uses B; or X uses both A and B, then “X uses A or B” is satisfied under any of the foregoing instances.

As used herein, the term “one of A, B, and C” shall be understood to mean “only A, only B, or only C,” and not a combination of A, B, and C.

As used herein, the term “one or more of A, B, and C” shall be understood to mean any one of A, B, or C, or any combination thereof, including multiple occurrences of each element. This includes, but is not limited to, the following configurations: only A, only B, only C, A and B, A and C, B and C, A, B, and C, as well as multiple instances of A, multiple instances of B, multiple instances of C, or any combination of multiple instances of A, B, and C.

As used herein, the term “at least one of A, B, and C” shall be understood to mean any one of A, B, or C, or any combination thereof, including multiple occurrences of each element. This includes, but is not limited to, the following configurations: only A, only B, only C, A and B, A and C, B and C, A, B, and C, as well as multiple instances of A, multiple instances of B, multiple instances of C, or any combination of multiple instances of A, B, and C.

As used herein, two or more elements or modules are “integral” or “integrated” if they operate functionally together. Two or more elements are “non-integral” if each element can operate functionally independently.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As used herein, the term “component” broadly construes hardware, firmware, and/or a combination of hardware, firmware, and software.

Digital electronic circuitry, or in computer software, firmware, or hardware, including the structures disclosed in this specification and their structural equivalents, or in combinations of one or more of them may realize the implementations and all of the functional operations described in this specification. Implementations may be as one or more computer program products, i.e., one or more modules of computer program instructions encoded on a computer-readable storage medium for execution by, or to control the operation of, data processing apparatus. The computer-readable storage medium may be a machine-readable storage device, a machine-readable storage substrate, a memory device, a composition of matter affecting a machine-readable propagated signal, or a combination of one or more of them. The term “computing system” encompasses all apparatus, devices, and machines for processing data, including by way of example, a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal (e.g., a machine-generated electrical, optical, or electromagnetic signal) that encodes information for transmission to a suitable receiver apparatus.

The actual specialized control hardware or software code used to implement these systems and/or methods is not limiting to the implementations. Thus, any software and any hardware can implement the systems and/or methods based on the description herein without reference to specific software code.

A computer program (also known as a program, software, software application, script, or code) is written in any appropriate form of programming language, including compiled or interpreted languages. Any appropriate form, including a standalone program or a module, component, subroutine, or other unit suitable for use in a computing environment may deploy it. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may execute on one computer or on multiple computers that are located at one site or distributed across multiple sites and interconnected by a communication network.

One or more programmable processors, executing one or more computer programs to perform functions by operating on input data and generating output, perform the processes and logic flows described in this specification. The processes and logic flows may also be performed by, and apparatus may also be implemented as special purpose logic circuitry, for example, without limitation, a Field Programmable Gate Array (FPGA), an Application Specific Integrated Circuit (ASIC), Application Specific Standard Products (ASSPs), System-On-a-Chip (SOC) systems, Complex Programmable Logic Devices (CPLDs), etc.

Processors suitable for the execution of a computer program include, by way of example, both general and special purpose microprocessors, and any one or more processors of any appropriate kind of a digital computer. A processor will receive instructions and data from a read-only memory or a random access memory or both. Elements of a computer can include a processor for performing instructions and one or more memory devices for storing instructions and data. A computer will also include, or is operatively coupled to receive data, transfer data or both, to/from one or more mass storage devices for storing data e.g., magnetic disks, magneto optical disks, optical disks, or solid-state disks. However, a computer need not have such devices. Moreover, another device, e.g., a mobile telephone, a personal digital assistant (PDA), a mobile audio player, a Global Positioning System (GPS) receiver, etc. may embed a computer. Computer-readable media suitable for storing computer program instructions and data include all forms of non-volatile memory, media and memory devices, including, by way of example, semiconductor memory devices (e.g., Erasable Programmable Read-Only Memory (EPROM), Electronically Erasable Programmable Read-Only Memory (EEPROM), and flash memory devices), magnetic disks (e.g., internal hard disks or removable disks), magneto optical disks (e.g. Compact Disk Read-Only Memory (CD ROM) disks, Digital Versatile Disk-Read-Only Memory (DVD-ROM) disks) and solid-state disks. Special purpose logic circuitry may supplement or incorporate the processor and the memory.

To provide for interaction with a user, a computer may have a display device, e.g., a Cathode Ray Tube (CRT) or Liquid Crystal Display (LCD) monitor, for displaying information to the user, and a keyboard and a pointing device, e.g., a mouse or a trackball, by which the user may provide input to the computer. Other kinds of devices provide for interaction with a user as well. For example, feedback to the user may be any appropriate form of sensory feedback, e.g., visual feedback, auditory feedback, or tactile feedback; and a computer may receive input from the user in any appropriate form, including acoustic, speech, or tactile input.

A computing system that includes a back-end component, e.g., a data server, or that includes a middleware component, e.g., an application server, or that includes a front-end component, e.g., a client computer having a graphical user interface or a Web browser through which a user may interact with an implementation, or any appropriate combination of one or more such back-end, middleware, or front-end components, may realize implementations described herein. Any appropriate form or medium of digital data communication, e.g., a communication network may interconnect the components of the system. Examples of communication networks include a Local Area Network (LAN) and a Wide Area Network (WAN), e.g., Intranet and Internet.

The computing system may include clients and servers. A client and server are remote from each other and typically interact through a communication network. The relationship between the client and server arises by virtue of computer programs running on the respective computers and having a client-server relationship with each other.

Embodiments may comprise or utilize a special purpose or general purpose computer including computer hardware. Embodiments within the scope of the present disclosure may also include physical and other computer-readable media for carrying or storing computer-executable instructions and/or data structures. Such computer-readable media can be any media accessible by a general purpose or special purpose computer system. Computer-readable media that store computer-executable instructions are physical storage media. Computer-readable media that carry computer-executable instructions are transmission media. Thus, by way of example and not limitation, embodiments can comprise at least two distinct kinds of computer-readable media: physical computer-readable storage media and transmission computer-readable media.

Although the present embodiments described herein are with reference to specific example embodiments it will be evident that various modifications and changes may be made to these embodiments without departing from the broader spirit and scope of the various embodiments. For example, hardware circuitry (e.g., Complementary Metal Oxide Semiconductor (CMOS) based logic circuitry), firmware, software (e.g., embodied in a non-transitory machine-readable medium), or any combination of hardware, firmware, and software may enable and operate the various devices, units, and modules described herein. For example, transistors, logic gates, and electrical circuits (e.g., Application Specific Integrated Circuit (ASIC) and/or Digital Signal Processor (DSP) circuit) may embody the various electrical structures and methods.

In addition, a non-transitory machine-readable medium and/or a system may embody the various operations, processes, and methods disclosed herein. Accordingly, the specifications and drawings are illustrative rather than restrictive.

Physical computer-readable storage media includes random access memory (RAM), read-only memory (ROM), electrically erasable programmable read-only memory (EEPROM), compact disk read-only memory (CD-ROM) or other optical disk storage (such as compact discs (CDs), digital versatile disks (DVDs), etc.), magnetic disk storage or other magnetic storage devices, solid-state disks or any other medium. They store the desired program code in the form of computer-executable instructions or data structures which can be accessed by a general purpose or special purpose computer.

As used herein, the term “network” refers to one or more data links that enable the transport of electronic data between computer systems and/or modules and/or other electronic devices. When a network or another communications connection (either hardwired, wireless, or a combination of hardwired or wireless) transfers or provides information to a computer, the computer properly views the connection as a transmission medium. A general purpose or special purpose computer access transmission media that can include a network and/or data links which carry desired program code in the form of computer-executable instructions or data structures. The scope of computer-readable media includes combinations of the above, that enable the transport of electronic data between computer systems and/or modules and/or other electronic devices.

Further, upon reaching various computer system components, program code in the form of computer-executable instructions or data structures can be transferred automatically from transmission computer-readable media to physical computer-readable storage media (or vice versa). For example, computer-executable instructions or data structures received over a network or data link can be buffered in RAM within a Network Interface Circuit (NIC), and then eventually transferred to computer system RAM and/or to less volatile computer-readable physical storage media at a computer system. Thus, computer system components that also (or even primarily) utilize transmission media may include computer-readable physical storage media.

Computer-executable instructions comprise, for example, instructions and data which cause a general purpose computer, special purpose computer, or special purpose processing device to perform a certain function or group of functions. The computer-executable instructions may be, for example, binary, intermediate format instructions such as assembly language, or even source code. Although the subject matter herein described is in a language specific to structural features and/or methodological acts, the described features or acts described do not limit the subject matter defined in the claims. Rather, the herein described features and acts are example forms of implementing the claims.

While this specification contains many specifics, these do not construe as limitations on the scope of the disclosure or of the claims, but as descriptions of features specific to particular implementations. A single implementation may implement certain features described in this specification in the context of separate implementations. Conversely, multiple implementations separately or in any suitable sub-combination may implement various features described herein in the context of a single implementation. Moreover, although features described herein as acting in certain combinations and even initially claimed as such, one or more features from a claimed combination may in some cases be excised from the combination, and the claimed combination may be directed to a sub-combination or variation of a sub-combination.

Similarly, while operations depicted herein in the drawings in a particular order to achieve desired results, this should not be understood as requiring that such operations be performed in the particular order shown or in sequential order or that all illustrated operations be performed, to achieve desirable results. In certain circumstances, multitasking and parallel processing may be advantageous. Moreover, the separation of various system components in the implementations should not be understood as requiring such separation in all implementations, and it should be understood that the described program components and systems may be integrated together in a single software product or packaged into multiple software products.

Even though particular combinations of features are recited in the claims and/or disclosed in the specification, these combinations are not intended to limit the disclosure of possible implementations. Other implementations are within the scope of the claims. For example, the actions recited in the claims may be performed in a different order and still achieve desirable results. In fact, many of these features may be combined in ways not specifically recited in the claims and/or disclosed in the specification. Although each dependent claim may directly depend on only one claim, the disclosure of possible implementations includes each dependent claim in combination with every other claim in the claim set.

Further, a computer system including one or more processors and computer-readable media such as computer memory may practice the methods. In particular, one or more processors execute computer-executable instructions, stored in the computer memory, to perform various functions such as the acts recited in the embodiments.

Those skilled in the art will appreciate that the disclosure may be practiced in network computing environments with many types of computer system configurations including personal computers, desktop computers, laptop computers, message processors, hand-held devices, multi-processor systems, microprocessor-based or programmable consumer electronics, network PCs, mini-computers, mainframe computers, mobile telephones, PDAs, pagers, routers, switches, etc. Distributed system environments where local and remote computer systems, which are linked (either by hardwired data links, wireless data links, or by a combination of hardwired and wireless data links) through a network, both perform tasks may also practice the disclosure. In a distributed system environment, program modules may be located in both local and remote memory storage devices.

Unless otherwise defined herein, scientific and technical terms used in connection with the present disclosure shall have the meanings that are commonly understood by those of ordinary skill in the art. Further, unless otherwise required by context, singular terms shall include pluralities, and plural terms shall include the singular. Generally, nomenclatures used in connection with, and techniques of, thermal management system of the vehicle as described herein are those well-known and commonly used in the art.

The methods and techniques of the present disclosure are generally performed according to conventional methods well-known in the art and as described in various general and more specific references that are cited and discussed throughout the present specification unless otherwise indicated. The nomenclatures used in connection with, and the procedures and techniques of embodiments herein, and other related fields described herein are those well-known and commonly used in the art.

The following terms and phrases, unless otherwise indicated, shall be understood to have the following meanings.

As used herein, the term “API” stands for Application Programming Interface. It is an interface that defines interactions between multiple software applications or mixed hardware-software intermediaries. It defines the kinds of calls or requests that can be made, how to make them, the data formats that should be used, the conventions to follow, etc. It can also provide extension mechanisms so that users can extend existing functionality in numerous ways and to varying degrees. An API can be entirely custom, specific to a component, or designed based on an industry standard to ensure interoperability. Through information hiding, APIs enable modularity, allowing users to use the interface independently of the implementation. Web APIs are now the most common meaning of the term API. There are also APIs for programming languages, software libraries, computer operating systems, and computer hardware.

The network may dynamically derive the APIs. In other implementations, the APIs may be derived from API records that are stored by the network. Additionally, when new APIs are derived for a particular network service, the APIs may be recorded in case a similar network service request (e.g., from another user) is received, in which case the record may be promptly used to determine the appropriate API, or set of APIs, for the requested network service.

The API request (e.g., for a name, an ID, or another type of information in the request) may correspond to network interactions, communications, events, etc., that are to occur in order to provide the network service. Libraries/repositories of the Software Defined Networking (SDN) may also store the chain of network interactions, communications, events, etc. APIs may be derived based on the characteristics of each of the interactions, communications, events, etc., being mapped to characteristics of APIs (also stored in libraries/repositories of the SDN architecture).

As used herein, the term “Cryptographic protocol” is also known as security protocol or encryption protocol. It is an abstract or concrete protocol that performs a security-related function and applies cryptographic methods often as sequences of cryptographic primitives. A protocol describes usage of the algorithms. A sufficiently detailed protocol includes details about data structures and representations, to implement multiple, interoperable versions of a program.

Secure application-level data transport widely uses cryptographic protocols. A cryptographic protocol usually incorporates at least some of these aspects: key agreement or establishment, entity authentication, symmetric encryption, and message authentication material construction, secured application-level data transport, non-repudiation methods, secret sharing methods, and secure multi-party computation.

Networking switches use cryptographic protocols, like Secure Socket Layer (SSL) and Transport Layer Security (TLS), the successor to SSL, to secure data communications over a wireless network.

As used herein, the term “Unauthorized access” is when someone gains access to a website, program, server, service, or other system using someone else's account or other methods. For example, if someone kept guessing a password or username for an account that was not theirs until they gained access, it is considered unauthorized access.

As used herein, the term “IoT” stands for Internet of Things which describes the network of physical objects “things” or objects embedded with sensors, software, and other technologies for the purpose of connecting and exchanging data with other devices and systems over the internet.

As used herein “Machine learning” refers to algorithms that give a computer the ability to learn without explicit programming, including algorithms that learn from and make predictions about data. Machine learning techniques include, but are not limited to, support vector machine, artificial neural network (ANN), logistic regression, discriminant analysis, random forest, linear regression, Naive Bayes, nearest neighbor, decision tree, and hidden Markov, etc. For clarity purposes, part of a machine learning process can use algorithms such as linear regression or logistic regression. However, using linear regression or another algorithm as part of a machine learning process is distinct from performing a statistical analysis such as regression with a spreadsheet program. The machine learning process can continually learn and adjust the classifier as new data becomes available and does not rely on explicit or rules-based programming. The ANN may be featured with a feedback loop to adjust the system output dynamically as it learns from the new data as it becomes available. In machine learning, backpropagation and feedback loops are used to train the Artificial Intelligence/Machine Learning (AI/ML) model, improving the model's accuracy and performance over time.

Statistical modeling relies on finding relationships between variables (e.g., mathematical equations) to predict an outcome.

As used herein, the term “Dashboard” is a type of interface that visualizes particular Key Performance Indicators (KPIs) for a specific goal or process. It is based on data visualization and infographics.

As used herein, a “Database” is a collection of organized information so that it can be easily accessed, managed, and updated. Computer databases typically contain aggregations of data records or files. As used herein, the term “Data set” (or “Dataset”) is a collection of data. In the case of tabular data, a data set corresponds to one or more database tables, where every column of a table represents a particular variable, and each row corresponds to a given record of the data set in question. The data set lists values for each of the variables, such as height and weight of an object, for each member of the data set. Each value is known as a datum. Data sets can also consist of a collection of documents or files.

As used herein, a “Sensor” is a device that detects and measures physical properties from the surrounding environment and converts this information into electrical or digital signals for further processing. Sensors play a crucial role in collecting data for various applications across industries. Sensors may be made of electronic, mechanical, chemical, or other engineering components. Examples include sensors to measure temperature, pressure, humidity, proximity, light, acceleration, orientation etc. The term “environment” or “surrounding” as used herein refers to surroundings and the space in which a vehicle is navigating. It refers to dynamic surroundings in which a vehicle is navigating which includes other vehicles, obstacles, pedestrians, lane boundaries, traffic signs and signals, speed limits, potholes, snow, water logging etc.

The term “autonomous mode” as used herein refers to an operating mode which is independent and unsupervised.

The term “vehicle” as used herein refers to a thing used for transporting people or goods. Automobiles, cars, trucks, buses, etc., are examples of vehicles. Further, the vehicle may include electric vehicles (EVs), hybrid electric vehicles (HEVs) such as, without limitations, full hybrid electric vehicles (FHEVs) and mild hybrid electric vehicles (MHEVs), battery electric vehicles (BEVs), and plug-in hybrid electric vehicles (PHEVs).

The term “autonomous vehicle” also referred to as self-driving vehicle, driverless vehicle, robotic vehicle as used herein refers to a vehicle incorporating vehicular automation, that is, a vehicle that can sense its environment and move safely with little or no human input. Self-driving vehicles combine a variety of sensors to perceive their surroundings, such as thermographic cameras, Radio Detection and Ranging (RADAR), Light Detection and Ranging (LIDAR), Sound Navigation and Ranging (SONAR), Global Positioning System (GPS), odometry and inertial measurement unit. Control systems are designed for the purpose of interpreting sensor information to identify appropriate navigation paths, as well as obstacles and relevant signage.

The term “communication module” or “communication system” as used herein refers to a system which enables the information exchange between two points. The process of transmission and reception of information is called communication. The elements of communication include but are not limited to a transmitter of information, channel or medium of communication and a receiver of information.

The term “autonomous communication” as used herein comprises communication over a period with minimal supervision under different scenarios and is not solely or completely based on pre-coded scenarios or pre-coded rules or a predefined protocol. Autonomous communication, in general, happens in an independent and an unsupervised manner. In an embodiment, a communication module is enabled for autonomous communication.

The term “communication connection” or “communication network” as used herein refers to a communication link. It refers to a communication channel that connects two or more devices for the purpose of data transmission. It may refer to a physical transmission medium such as a wire, or to a logical connection over a multiplexed medium such as a radio channel in telecommunications and computer networks. A channel is used for the transfer of information, for example, a digital bit stream, from one or several senders to one or several receivers. A channel has a certain capacity for transmitting information, often measured by its bandwidth in Hertz (Hz) or its data rate in bits per second. For example, a Vehicle-to-Vehicle (V2V) communication may wirelessly exchange information about the speed, location and heading of surrounding vehicles. Similarly, a Vehicle-to-Grid (V2G) communication may exchange charge information and further transfer charge from the vehicle to the grid.

The term “communication” as used herein refers to the transmission of information and/or data from one point to another. Communication may be by means of electromagnetic waves. Communication is also a flow of information from one point, known as the source, to another, the receiver. Communication comprises one of the following: transmitting data, instructions, information or a combination of data, instructions, and information. Communication happens between any two communication systems or communicating units. The term communication, herein, includes systems that combine other more specific types of communication, such as: V2I (Vehicle-to-Infrastructure), V2N (Vehicle-to-Network), V2V (Vehicle-to-Vehicle), V2P (Vehicle-to-Pedestrian), V2D (Vehicle-to-Device), V2G (Vehicle-to-Grid), and Vehicle-to-Everything (V2X) communication.

The term “Vehicle-to-Vehicle (V2V) communication” refers to the technology that allows vehicles to broadcast and receive messages. The messages may be omni-directional messages, creating a 360-degree “awareness” of other vehicles in proximity. Vehicles may be equipped with appropriate software (or safety applications) that can use the messages from surrounding vehicles to determine potential crash threats as they develop.

The term “Vehicle-to-Everything (V2X) communication” as used herein refers to transmission of information from a vehicle to any entity that may affect the vehicle, and vice versa. Depending on the underlying technology employed, there are two types of V2X communication technologies: cellular networks and other technologies that support direct device-to-device communication (such as Dedicated Short-Range Communication (DSRC), Port Community System (PCS), Bluetooth®, Wi-Fi®, etc.).

The term “protocol” as used herein refers to a procedure required to initiate and maintain communication; a formal set of conventions governing the format and relative timing of message exchange between two communications terminals; a set of conventions that govern the interactions of processes, devices, and other components within a system; a set of signaling rules used to convey information or commands between boards connected to the bus; a set of signaling rules used to convey information between agents; a set of semantic and syntactic rules that determine the behavior of entities that interact; a set of rules and formats (semantic and syntactic) that determines the communication behavior of simulation applications; a set of conventions or rules that govern the interactions of processes or applications between communications terminals; a formal set of conventions governing the format and relative timing of message exchange between communications terminals; a set of semantic and syntactic rules that determine the behavior of functional units in achieving meaningful communication; a set of semantic and syntactic rules for exchanging information.

The term “communication protocol” as used herein refers to standardized communication between any two systems. An example of communication protocol is the DSRC protocol. The DSRC protocol uses a specific frequency band (e.g., 5.9 GHz (Gigahertz)) and specific message formats (such as the Basic Safety Message, Signal Phase and Timing, and Roadside Alert) to enable communications between vehicles and infrastructure components, such as traffic signals and roadside sensors. DSRC is a standardized protocol, and its specifications are maintained by various organizations, including the Institute of Electrical and Electronics Engineers (IEEE) and Society of Automotive Engineers (SAE) International.

The term “bi-directional communication” as used herein refers to an exchange of data between two components. In an example, the first component can be a vehicle, and the second component can be an infrastructure that is enabled by a system of hardware, software, and firmware. In an example, the second component can be an energy source capable of charging a vehicle battery and accepting charge from the vehicle battery.

The term “in communication with” as used herein, refers to any coupling, connection, or interaction using signals to exchange information, message, instruction, command, and/or data, using any system, hardware, software, protocol, or format regardless of whether the exchange occurs wirelessly or over a wired connection.

The term “electronic control unit” (ECU), also known as an “electronic control module”, is usually a module that controls one or more subsystems. Herein, an ECU may be installed in a vehicle or other motor vehicle. It may refer to many ECUs, and can include but not limited to, Engine Control Module (ECM), Powertrain Control Module (PCM), Transmission Control Module (TCM), Brake Control Module or Electronic Brake Control Module (EBCM), Central Control Module (CCM), Central Timing Module (CTM), General Electronic Module (GEM), Body Control Module (BCM), and Suspension Control Module (SCM). ECUs together are sometimes referred to collectively as the vehicles'computer or vehicles'central computer and may include separate computers. In an example, the electronic control unit can be an embedded system in automotive electronics. In another example, the electronic control unit is wirelessly coupled with automotive electronics.

The terms “non-transitory computer-readable medium” and “computer-readable medium” include a single medium or multiple media such as a centralized or distributed database, and/or associated caches and servers that store one or more sets of instructions. Further, the terms “non-transitory computer-readable medium” and “computer-readable medium” include any tangible medium that is capable of storing, encoding, or carrying a set of instructions for execution by a processor that, for example, when executed, cause a system to perform any one or more of the methods or operations disclosed herein. As used herein, the term “computer-readable medium” is expressly defined to include any type of computer-readable storage device and/or storage disk and to exclude propagating signals.

The term “Vehicle Data bus” as used herein represents the interface to the vehicle data bus (e.g., Controller Area Network (CAN), Local Interconnect Network (LIN), Ethernet/IP, FlexRay, and Media Oriented Systems Transport (MOST)) that may enable communication between the Vehicle on-board equipment (OBE) and other vehicle systems to support connected vehicle applications.

The term, “handshaking” refers to an exchange of predetermined signals between agents connected by a communications channel to assure each that it is connected to the other (and not to an imposter). This may also include the use of passwords and codes by an operator. Handshaking signals are transmitted back and forth over a communications network to establish a valid connection between two stations. A hardware handshake uses dedicated wires such as the request-to-send (RTS) and clear-to-send (CTS) lines in a Recommended Standard 232 (RS-232) serial transmission. A software handshake sends codes such as “synchronize” (SYN) and “acknowledge” (ACK) in a Transmission Control Protocol/Internet Protocol (TCP/IP) transmission.

The term “computer vision module” or “computer vision system” allows the vehicle to “see” and interpret the world around it. This system uses a combination of cameras, sensors, and other technologies such as Radio Detection and Ranging (RADAR), Light Detection and Ranging (LIDAR), Sound Navigation and Ranging (SONAR), Global Positioning System (GPS), and Machine learning algorithms, etc. to collect visual data about the vehicle's surroundings and to analyze that data in real-time. The computer vision system is designed to perform a range of tasks, including object detection, lane detection, and pedestrian recognition. It uses deep learning algorithms and other machine learning techniques to analyze visual data and make decisions about how to control the vehicle. For example, the computer vision system may use object detection algorithms to identify other vehicles, pedestrians, and obstacles in the vehicle's path. It can then use this information to calculate the vehicle's speed and direction, adjust its trajectory to avoid collisions, and apply the brakes or accelerate as needed. It allows the vehicle to navigate safely and efficiently in a variety of driving conditions.

As used herein, the term “driver” refers to such an occupant, even when that occupant is not actually driving the vehicle but is situated in the vehicle so as to be able to take over control and function as the driver of the vehicle when the vehicle control system hands over control to the occupant or driver or when the vehicle control system is not operating in an autonomous or semi-autonomous mode. The driver is also referred to as an operator of the vehicle.

The term “application server” refers to a server that hosts applications or software that delivers a business application through a communication protocol. An application server framework is a service layer model. It includes software components available to a software developer through an application programming interface. It is system software that resides between the operating system (OS) on one side, the external resources such as a database management system (DBMS), communications and Internet services on another side, and the users'applications on the third side.

The term “cyber security” as used herein refers to application of technologies, processes, and controls to protect systems, networks, programs, devices, and data from cyber-attacks.

The term “cyber security module” as used herein refers to a module comprising application of technologies, processes, and controls to protect systems, networks, programs, devices and data from cyber-attacks and threats. It aims to reduce the risk of cyber-attacks and protect against the unauthorized exploitation of systems, networks, and technologies. It includes, but is not limited to, critical infrastructure security, application security, network security, cloud security, Internet of Things (IoT) security.

The term “encrypt” used herein refers to securing digital data using one or more mathematical techniques, along with a password or “key” used to decrypt the information. It refers to converting information or data into a code, especially to prevent unauthorized access. It may also refer to concealing information or data by converting it into a code. It may also be referred to as cipher, code, encipher, encode. A simple example is representing alphabets with numbers—say, ‘A’ is ‘01’, ‘B’ is ‘02’, and so on. For example, a message like “HELLO” will be encrypted as “0805121215,” and this value will be transmitted over the network to the recipient(s).

The term “decrypt” used herein refers to the process of converting an encrypted message back to its original format. It is generally a reverse process of encryption. It decodes the encrypted information so that only an authorized user can decrypt the data because decryption requires a secret key or password. This term could be used to describe a method of unencrypting the data manually or unencrypting the data using the proper codes or keys.

The term “cyber security threat” used herein refers to any possible malicious attack that seeks to unlawfully access data, disrupt digital operations, or damage information. A malicious act includes but is not limited to damaging data, stealing data, or disrupting digital life in general. Cyber threats include, but are not limited to, malware, spyware, phishing attacks, ransomware, zero-day exploits, trojans, advanced persistent threats, wiper attacks, data manipulation, data destruction, rogue software, malvertising, unpatched software, computer viruses, man-in-the-middle attacks, data breaches, Denial of Service (DoS) attacks, and other attack vectors.

The term “hash value” used herein can be thought of as fingerprints for files. The contents of a file are processed through a cryptographic algorithm, and a unique numerical value, the hash value, is produced that identifies the contents of the file. If the contents are modified in any way, the value of the hash will also change significantly. Example algorithms used to produce hash values: the Message Digest-5 (MD5) algorithm and Secure Hash Algorithm-1 (SHA1).

The term “integrity check” as used herein refers to the checking for accuracy and consistency of system related files, data, etc. It may be performed using checking tools that can detect whether any critical system files have been changed, thus enabling the system administrator to look for unauthorized alteration of the system. For example, data integrity corresponds to the quality of data in the databases and to the level by which users examine data quality, integrity, and reliability. Data integrity checks verify that the data in the database is accurate, and functions as expected within a given application.

The term “alarm” as used herein refers to a trigger when a component in a system or the system fails or does not perform as expected. The system may enter an alarm state when a certain event occurs. An alarm indication signal is a visual signal to indicate the alarm state. For example, when a cyber security threat is detected, a system administrator may be alerted via sound alarm, a message, a glowing LED, a pop-up window, etc. Alarm indication signal may be reported downstream from a detecting device, to prevent adverse situations or cascading effects.

As used herein, the term “cryptographic protocol” is also known as security protocol or encryption protocol. It is an abstract or concrete protocol that performs a security-related function and applies cryptographic methods often as sequences of cryptographic primitives. A protocol describes how the algorithms should be used. A sufficiently detailed protocol includes details about data structures and representations, at which point it can be used to implement multiple, interoperable versions of a program. Cryptographic protocols are widely used for secure application-level data transport. A cryptographic protocol usually incorporates at least some of these aspects: key agreement or establishment, entity authentication, symmetric encryption, and message authentication material construction, secured application-level data transport, non-repudiation methods, secret sharing methods, and secure multi-party computation. Hashing algorithms may be used to verify the integrity of data. Secure Socket Layer (SSL) and Transport Layer Security (TLS), the successor to SSL, are cryptographic protocols that may be used by networking switches to secure data communication over a network.

As used herein the term “thermal requirement” refers to the energy required by a component in the vehicle for its operation i.e., each component in the vehicle requires a certain amount of energy for its operation and the energy may comprise one or more of heat energy, voltage, and current. For example, heat energy may be required by the battery management system (BMS) to pre-heat the battery before charging or discharging operation or the air conditioning system of the vehicle to heat the vehicle cabin during cold weather.

As used herein the term “active region” refers to an operational region of any electronic switch in which a larger output current or voltage is controlled by a smaller input signal.

Heat management or thermal management plays a crucial role in vehicles as optimal thermal management enables optimal performance of vehicles. Motors in vehicles generate heat when they are used. Heat generated by the motors is considered as wasted energy. Vehicles with internal combustion engines use a part of the wasted energy (i.e., the heat generated by the motor) for cabin heating and window de-icing predominantly during cold weather conditions. In the case of electric vehicles (EV), the amount of heat generated by motors is very little (since electric vehicles are more efficient). This means that heat requirements in electric vehicles for any additional purpose must be generated specifically for that purpose. In general, heat required for the overall operation of the vehicle is managed by a thermal management system of the vehicle. However, the heat required for any additional operation, for example, heating of the vehicle cabin and heating of the battery for optimal performance may be generated by an additional component in the vehicle. The heat required for additional operation, i.e., additional heat may be generated using dedicated components or by operating the existing components of the vehicle in a heat generation mode. The use of dedicated components increases costs and adds weight and volume to the vehicle which is not desired. On the other hand, operating the existing components in the heat generation mode may result in generating a limited amount of heat or may compromise the main functionality of the component.

Currently, vehicles use a traction inverter in a heat generation mode for generating additional heat. Traction inverters are used to drive the electric motor, wherein the main operation of the traction inverter is to convert battery energy or direct current into power and thereby control torque and speed of the electric motor. The use of the traction inverter in the heat generation mode results in a limited amount of heat and impacts the torque availability for the electric motor. Further, the use of the traction inverter in the heat generation mode affects the lifetime of the traction inverter.

In one aspect the present disclosure is directed towards the use of an on-board charger (OBC) as a device to produce the additional heat required in the vehicle. The OBC may be used in a heat generation mode when the vehicle is not charging or discharging or when the vehicle is using direct current (DC) fast charging. In some embodiments, the OBC may be used in the heat generation mode independent of the traction inverter being used in the heat generation mode. In some embodiments, the OBC may be used in the heat generation mode along with the traction inverter being used in the heat generation mode.

In some embodiments, one or more phase legs of the OBC are configured to act as switches. Gate voltages to the switches in the OBC are controlled such that the switches operate in the active region. For example, controlling the gate voltage of the switch controls the conductive resistance of the switch. Further, controlling a direct current to direct current (DC-DC) converter associated with the OBC enables controlling the amount of power being converted to heat.

The use of OBC in generating the additional heat has the following advantages:
a. Enables a way to produce additional heat without impacting the traction inverter and in turn the drivability of the vehicle.
b. Enables more efficient ways of moving the additional heat that is created to the place where it is needed as the OBC typically forms a part of a thermal system associated with the vehicle and is connected to circuits and components in the thermal system.
c. Increases the thermal coupling between the heat generators (i.e., components in the thermal system that generate heat) and consumers (i.e., one or more components in the vehicle that requires the heat for its operation).

In some embodiments, the three phase legs in the OBC may be configured to represent 6 switches, wherein all these switches may be controlled as valves by applying a gate voltage (V_{GE}). By increasing the gate voltage, the switch can conduct more and more current for a given external voltage V_{CE}. Electrical power is given as voltage across a device multiplied with the current through it. Therefore, the power across the switch may be varied by varying V_{GE} and V_{CE}. In some embodiments, V_{GE} may be controlled using special gate driver circuits and V_{CE} may be controlled by the DC-DC converter that is associated with the OBC. In some embodiments, in the heat generation mode the DC-DC converter may take power from the vehicle battery. In some embodiments, the DC-DC converter may be controlled to produce the V_{CE} that is needed for generating the desired amount of heat.

In some embodiments, the gate voltage of each switch may be controlled individually to achieve a suitable level of impedance resulting in generating the desired amount of heat. The gate voltage may be controlled using at least one of: dedicated smart gate driver circuits, a switched gate voltage circuit where a gate voltage is applied only for a controlled time resulting in a selectable gate voltage, and gate drivers dedicated for heat production. In some embodiments, the gate drivers dedicated for heat production have different output voltages as compared with gate drivers used for charging operation. Each switch includes a specific relation between gate voltage and device impedance, therefore a software controller may select a correct gate voltage in relation to the high voltage applied to the device (for example, collector-emitter voltage or drain-source voltage depending on the type of switch), wherein the high voltage is controlled by the DC-DC associated with the on-board charger. In some embodiments, the high voltage is selected based on system needs such as efficiency, components to be used, and the amount of additional heat required to be generated.

In some embodiments, a software-based controller may be implemented to generate the desired amount of heat wherein the software-based controller may control VGE and VCE to generate the required additional heat. In some embodiments, VCE is controlled by controlling the operation of the DC-DC converter.

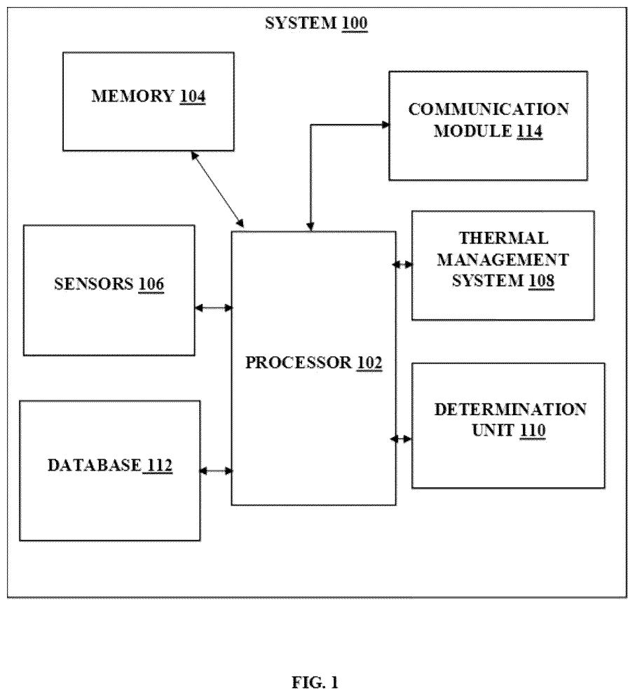

FIG. 1 illustrates a block diagram of a system associated with a vehicle according to an embodiment.

System 100 comprises processor 102, memory 104, sensors 106, thermal management system 108, determination unit 110, database 112, and communication module 114. In some embodiments, an on-board charger (OBC) is a component associated with the thermal management system.

Referring to FIG. 1, processor 102 may be a high-performance, multi-core CPU or system-on-chip (SoC) solution to process vast amounts of data. In some embodiments, processor 102 is communicatively coupled to sensors 106 and thermal management system 108 to obtain heat requirement associated with the thermal management system. In some embodiments, determination unit 110 may determine the additional heat to be generated by the OBC based on the heat requirement obtained from the thermal management system.

Processor 102 may comprise Graphics Processing Units (GPUs). GPUs are utilized for their ability to accelerate tasks like image and sensor data processing. Some vehicles may incorporate Field-Programmable Gate Arrays (FPGAs) to efficiently perform specialized computations, while others might leverage Application-Specific Integrated Circuits (ASICs) for optimized functions. The choice of processors depends on factors such as the vehicle's level of autonomy, processing requirements, power consumption, and thermal considerations. Processors, also known as central processing units (CPUs), are the heart and brain of any computer or electronic device capable of executing instructions. Processor or processors'function is to process data and perform calculations, etc. At the core of their operation lies data processing, where they handle arithmetic and logical operations on data stored in memory. CPUs execute instructions, which are sets of specific operations encoded in machine language, to perform various tasks. The control unit within, or interacting with, the processor manages and coordinates the execution of instructions, fetching them from memory, decoding them, and directing the appropriate components to execute the instruction. To ensure a controlled and orderly flow of tasks, processors use an internal clock that generates regular electrical pulses, synchronizing their operations through clock cycles. Processors support multitasking environments, rapidly switching between executing different tasks for various applications. Additionally, they may work with the operating system to manage virtual memory, allowing programs to access more memory than is physically available, and to efficiently manage memory usage. Processor or processors may be integrated with security features, including hardware-level encryption, memory protection, and support for secure execution environments, enhancing the system's security against potential threats. The processor may run sophisticated algorithms and artificial intelligence (AI) software to analyze sensor data, determine conditions associated with the vehicle and a user of the vehicle, interpret the environment, and help in decision making. Its high-performance capabilities and parallel processing help ensure the vehicle can perceive and respond to its surroundings quickly and accurately. In an embodiment, the processor may be a neuromorphic processor, inspired by the human brain, which offers a unique approach to handling AI tasks. Processor 102 interacts with and exchanges data with one or more of the other components or modules of the system, for example, memory 104, sensors 106, thermal management system 108, determination unit 110, database 112, and communication module 114.

Referring to FIG. 1, memory 104 may be a non-volatile memory (NVM) which is utilized in reliable operations of the system, ensuring that data is preserved even during power interruptions or failures. Various NVM technologies are utilized, such as flash memory for storing the operating system and software, EEPROM for retaining configuration data, calibration values, and sensor settings, Ferroelectric RAM (FRAM) for critical real-time information, and emerging technologies like resistive RAM (ReRAM) for potential performance enhancements due to its high-speed operation and low power consumption. In an embodiment, the memory may be a cloud-based memory. In another embodiment, the memory may be a local memory. In another embodiment, it may be a combination of local and cloud-based memory. Local memory refers to the traditional memory components present in a physical device, such as a computer's RAM, hard disk drives (HDDs), or solid-state drives (SSDs). It provides fast access to data and is directly connected to the device, making it suitable for immediate processing tasks and offline use. On the other hand, cloud-based memory relies on remote servers and services provided by third-party cloud providers to store and manage data over the internet. Systems can access their data from anywhere with an internet connection, allowing for seamless collaboration and scalability. Cloud-based memory is often used for storing large amounts of data, enabling data sharing, and providing backup and disaster recovery solutions. The combination of local memory and cloud-based memory allows for flexible and efficient data management tailored to different needs of the system.

Referring to FIG. 1, sensors 106 may comprise various sensors such as a temperature sensor, ultrasonic sensors, LIDAR sensors, radar sensors, camera-based sensors, Infrared (IR) sensors, radio frequency identification (RFID) sensors, etc. Sensors, for example, cameras, LIDARs, radars, and ultrasonic sensors, enable autonomous vehicles to detect and recognize objects, obstacles, and pedestrians on the road to enable navigation of the autonomous vehicles. In some embodiments, communication module 114 facilitates communication between different modules within system 100, e.g., communication between the vehicle and other devices, other vehicles, and other infrastructure components or energy source, for example, grid, charging points, external servers, etc.

Referring to FIG. 1, in some embodiments, database 112 may store data associated with various sensors 106, determination unit 110, and thermal management system 108. In some embodiments, database 112 may be locally present in system 100 or may be present in a server associated with a manufacturer of the vehicle or in an external server. Processor 102 may fetch the data from the database to obtain heat requirement of the thermal management system, wherein the heat requirement of the thermal management system is based on at least one of ambient condition, on-going vehicle operations, anticipated vehicle operations, heat available in the thermal system, and energy available in the vehicle for generating the required amount of heat.

Referring to FIG. 1, communication module 114, determination unit 110, and thermal management system 108 are coupled to processor 102. Communication module 114 is operable to communicate with external devices and infrastructure devices. In some embodiments, the communication module transmits information associated with the heat requirement of the thermal management system to an external server, wherein the external server may process the information to determine if any additional heat is to be generated by the OBC and determine a gate voltage and an external voltage required to control the operation of one or more phase legs of the OBC to generate the additional heat.

In some embodiments, thermal management system 108, database 112, sensors 106, and determination unit 110 are communicatively coupled to processor 102. Thermal management system 108 provides a heat requirement to the processor based on at least one of: ambient condition, on-going vehicle operations, anticipated vehicle operations, heat available in the thermal management system, and energy available in the vehicle for generating the required amount of heat.

In some embodiments, the ambient condition comprises at least one of temperature outside the vehicle and cabin temperature. In some embodiments, the on-going vehicle operations comprises current operation status of the one or more components in the vehicle. In some embodiments, the anticipated vehicle operations comprises an operation status of the one or more components in the vehicle at a predefined time, wherein the one or more components comprises at least one of Battery Management System (BMS), Engine Control Module (ECM), Powertrain Control Module (PCM), Transmission Control Module (TCM), Brake Control Module or Electronic Brake Control module (ECBM), Central Control Module (CCM), Central Timing Module (CTM), General Electronic Module (GEM), Body Control Module (BCM), and Suspension Control Module (SCM).

Referring to FIG. 1, processor 102 is operable to: configure one or more phase legs of the on-board charger to operate as a switch; and control each of the switches associated with the one or more phase legs to generate the determined amount of heat.

In some embodiments, processor 102 is further operable to control each of the switches associated with the one or more phase legs based on a voltage applied at a gate terminal of each of the switches and an external voltage, wherein each of the switches is controlled to operate in an active region to generate the determined amount of heat.

In some embodiments, voltage applied at the gate terminal is determined based on the amount of heat to be generated by the on-board charger and the external voltage is set based on the amount of heat to be generated by the on-board charger.

In some embodiments, the external voltage is set based on controlling a direct current to direct current (DC-DC) converter.

In some embodiments, processor 102 is further operable to: distribute the heat generated by the on-board charger to the one or more components in the vehicle based on a thermal requirement associated with the one or more components in the vehicle. For example, the heat generated by the OBC may be used to heat the battery to increase performance with respect to both charging and discharging operation and may be used to heat the vehicle cabin to increase comfort.

Further, the OBC forms a part of thermal management system 108 and the generated heat may be used either in a single component of the one or more components in the vehicle or shared between the one or more components in the vehicle depending on the thermal requirement at each of the one or more components.

In some embodiments, the heat generated by the on-board charger is distributed equally to the one or more components in the vehicle.

In some embodiments, the heat generated by the on-board charger is distributed at different ratios to the one or more components in the vehicle.

In some embodiments, processor 102 is further operable to: determine a status of the vehicle and configure the one or more phase legs to operate as a switch based on the status of the vehicle, wherein the status of the vehicle comprises at least one of a charging status, a discharging status, and a direct current (DC) fast charging status. For example, charging/discharging a vehicle battery generates heat in the vehicle, in such situations the OBC may not be used for the purpose of generating the additional heat. On the other hand, while the vehicle is performing DC fast charging, OBC may be used in the heat generation mode to generate the additional heat required. In some embodiments, the phase legs are configured to operate as switches when the vehicle is not charging or discharging or when the vehicle is performing DC fast charging.

In some embodiments, processor 102 is further operable to: determine a maximum heat level associated with the on-board charger; and control the amount of heat to be generated by the on-board charger based on the maximum heat level, wherein the amount of heat to be generated by the on-board charger is less than the maximum heat level.

A person skilled in art may understand that system 100 is not limited to include only components as shown in FIG. 1 and may include further components based on the functionality of the system.

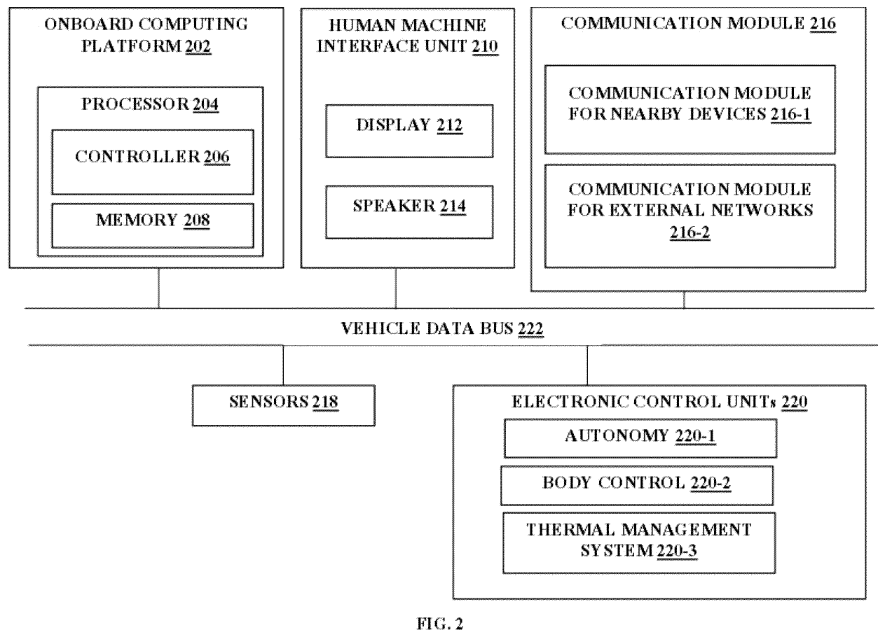

FIG. 2 illustrates a block diagram of electronic components of the vehicle according to an embodiment.

Referring to FIG. 2, the vehicle comprising various electronic components, such as, on-board computing platform 202, human-machine interface (HMI) unit 210, communication module 216, sensors 218, electronic control units (ECUs) 220, and vehicle data bus 222, is shown. FIG. 2 illustrates an example architecture of some of the electronic components, as shown in FIG. 1. On-board computing platform 202 comprises processor 204 (also referred to as a microcontroller unit or a controller) and memory 208. In the illustrated example, processor 204 of the on-board computing platform is structured to comprise controller 206. In other examples, controller 206 is incorporated into another ECU with its own processor and memory. The processor may be any suitable processing device or set of processing devices such as, but not limited to, a microprocessor, a microcontroller-based platform, an integrated circuit, one or more field-programmable gate arrays (FPGAs), and/or one or more application-specific integrated circuits (ASICs). The memory may be volatile memory (e.g., RAM including non-volatile RAM, magnetic RAM, ferroelectric RAM, etc.), non-volatile memory (e.g., disk memory, FLASH memory, EPROMs, EEPROMs, memristor-based non-volatile solid-state memory, etc.), unalterable memory (e.g., EPROMs), read-only memory, and/or high-capacity storage devices (e.g., hard drives, solid-state drives, etc.). In some examples, memory 208 comprises multiple kinds of memory, particularly volatile memory, and non-volatile memory. Memory 208 is a computer-readable media on which one or more sets of instructions, such as the software for operating the methods of the present disclosure, can be embedded. The instructions may embody one or more of the methods or logic as described herein. For example, the instructions reside completely, or at least partially, within any one or more of the memory 208, the computer-readable medium, and/or within processor 204 during execution of the instructions.

HMI unit 210 provides an interface between the vehicle and a user. HMI unit 210 comprises digital and/or analog interfaces (e.g., input devices and output devices) to receive input from, and display information for, the user(s). The input devices comprise, for example, a control knob, an instrument panel, a digital camera for image capture and/or visual command recognition, a touch screen, an audio input device (e.g., cabin microphone), buttons, or a touchpad. The output devices may comprise instrument cluster outputs (e.g., dials, lighting devices), haptic devices, actuators, display 212 (e.g., a heads-up display, a center console display such as a liquid crystal display (LCD), an organic light emitting diode (OLED) display, a flat panel display, a solid-state display, etc.), and/or speaker 214. For example, the display, the speaker, and/or other input and output device(s) of HMI unit 210 are operable to emit an alert, such as an alert to request manual takeover to an operator (e.g., a driver) of the vehicle. Further, the HMI unit of the illustrated example comprises hardware (e.g., a processor or controller, memory, storage, etc.) and software (e.g., an operating system, etc.) for an infotainment system that is presented via display 212.

Sensors 218 are arranged in and/or around the vehicle to monitor the interior regions of the vehicle and/or an environment in which the vehicle is driving. One or more of the sensors may be mounted to measure various parameters around an exterior of the vehicle. Additionally, or alternatively, one or more of sensors may be mounted inside a cabin of the vehicle or in a body of the vehicle (e.g., an engine compartment, wheel wells, etc.) to measure properties of the vehicle and/or interior sensing of the vehicle. For example, sensors 218 comprise accelerometers, odometers, tachometers, pitch and yaw sensors, wheel speed sensors, microphones, tire pressure sensors, biometric sensors, ultrasonic sensors, infrared sensors, Light Detection and Ranging (LIDAR/lidar), Radio Detection and Ranging System (radar), Global Positioning System (GPS), millimeter wave (mmWave) sensors, cameras and/or sensors of any other suitable type. According to an embodiment of the system, the one or more sensors associated with the vehicle comprises camera-based sensors or a camera coupled with a computer vision system.

In some embodiments, sensors 218 comprise temperature sensors and image sensors. Temperature sensors may be placed around an exterior of the vehicle to determine the temperature in the surroundings of the vehicle, and inside the vehicle to detect the cabin temperature.

Referring to FIG. 2, ECUs 220 monitor and control the subsystems of the vehicle. For example, ECUs 336 are discrete sets of electronics that comprise their own circuit(s) (e.g., integrated circuits, microprocessors, memory, storage, etc.) and firmware, sensors, actuators, and/or mounting hardware. ECUs 336 communicates and exchanges information via vehicle data bus 338. Additionally, the ECUs may communicate properties (e.g., status of the ECUs, sensor readings, control state, error, and diagnostic codes, etc.) and/or receive requests from each other. For example, the vehicle may have many ECUs that are positioned in various locations around the vehicle and are communicatively coupled by the vehicle data bus.

In the illustrated example, ECUs 336 comprise autonomy unit 336-1, body control unit 336-2, engine control unit 336-4 and battery management unit 336-3. For example, autonomy unit 336-1 is operable to perform autonomous and/or semi-autonomous driving maneuvers (e.g., defensive driving maneuvers) of the vehicle based upon, at least in part, instructions received from controller 322 and/or data collected by sensors 218 (e.g., object detection sensors). Further, body control unit 220-2 controls one or more subsystems throughout the vehicle, such as power windows, power locks, an immobilizer system, power mirrors, etc. For example, body control unit 220-2 comprises circuits that drive one or more relays (e.g., to control wiper fluid, etc.), brushed direct current (DC) motors (e.g., to control power seats, power locks, power windows, wipers, etc.), stepper motors, LEDs, safety systems (e.g., seatbelt pretensioner, air bags, etc.), etc. For example, thermal management system 220-3 (similar to thermal management system 108 of FIG. 1) is operable to provide a heat requirement based on at least one of: ambient condition, on-going vehicle operations, anticipated vehicle operations, heat available in the thermal management system, and energy available in the vehicle for generating the required amount of heat.

Referring to FIG. 2, vehicle data bus 222 communicatively couples communication module 216, on-board computing platform 202, HMI unit 210, sensors 218, and ECUs 220. In some examples, vehicle data bus 222 comprises one or more data buses. Vehicle data bus 222 may be implemented in accordance with a controller area network (CAN) bus protocol as defined by International Standards Organization (ISO) 11898-1, a Media Oriented Systems Transport (MOST) bus protocol, a CAN flexible data (CAN-FD) bus protocol (ISO 11898-7) and/a K-line bus protocol (ISO 9141 and ISO 14230-1), and/or an Ethernet™ bus protocol IEEE 802.3 (2002 onwards), etc.

Referring to FIG. 2, communication module 216 may comprise a near field communication module or a communication module for nearby device 216-1 and far field communication module or communication module for external network 216-2. Communication modules for nearby devices 216-1 are operable to communicate with other nearby communication devices. In an example, communication module 216 comprises a dedicated short-range communication (DSRC) module. A DSRC module comprises antenna(s), radio(s) and software to communicate with nearby vehicle(s) via vehicle-to-vehicle (V2V) communication, infrastructure-based module(s) via vehicle-to-infrastructure (V2I) communication, and/or, more generally, nearby communication device(s) (e.g., a mobile device-based module) via vehicle-to-everything (V2X) communication. V2V communication allows vehicles to share information such as speed, position, direction, and other relevant data, enabling them to cooperate and coordinate their actions to improve safety, efficiency, and mobility on the road. It may rely on dedicated short-range communication (DSRC) and other wireless protocols that enable fast and reliable data transmission between vehicles. V2V communication, which is a form of wireless communication between vehicles, allows vehicles to exchange information and coordinate with other vehicles on the road.

Additionally, or alternatively, communication module for external networks 216-2 comprises a cellular vehicle-to-everything (C-V2X) module. A C-V2X module comprises hardware and software to communicate with other vehicle(s) via V2V communication, infrastructure-based module(s) via V2I communication, and/or, more generally, nearby communication devices (e.g., mobile device-based modules) via V2X communication. For example, a C-V2X module is operable to communicate with nearby devices (e.g., vehicles, roadside units, mobile devices of users, etc.) directly and/or via cellular networks. Currently, standards related to C-V2X communication are being developed by the 3rd Generation Partnership Project. Further, communication module 216-2 is operable to communicate with external networks. For example, communication module 216-2 comprises hardware (e.g., processors, memory, storage, antenna, etc.) and software to control wired or wireless network interfaces. In the illustrated example, the communication module 216-2 comprises one or more communication controllers for wireless networks, satellite communication network, microwave communication network, fiber optic communication network, cellular networks (e.g., Global System for Mobile Communications (GSM), Universal Mobile Telecommunications System (UMTS), Long Term Evolution (LTE), Code Division Multiple Access (CDMA)), fifth generation 5G networks, Near Field Communication (NFC) and/or other standards-based networks (e.g., WiMAX (IEEE 802.16m), local area wireless network (including IEEE 802.11 a/b/g/n/ac or others), Wireless Gigabit (IEEE 802.11ad), etc.). In some examples, the communication module for external networks 216-2 comprises a wired or wireless interface (e.g., an auxiliary port, a Universal Serial Bus (USB) port, a Bluetooth® wireless node, etc.) to communicatively couple with a mobile device (e.g., a smart phone, a wearable, a smart watch, a tablet, etc.). In such examples, the vehicle may communicate with the external network via the coupled mobile device. The external network(s) may be a public network, such as the Internet, a private network, such as an intranet, or combinations thereof, and may utilize a variety of networking protocols now available or later developed including, but not limited to, TCP/IP-based networking protocols.

The communication module comprises a hardware component comprising, a vehicle gateway system comprising a microcontroller, a transceiver, a power management integrated circuit, an Internet of Things device capable of transmitting one of an analog and a digital signal over one of a telephone, a communication, either wired or wirelessly.

Autonomy unit 220-1 of the illustrated example is operable to perform autonomous and/or semi-autonomous driving maneuvers, such as defensive driving maneuvers, for the vehicle. For example, autonomy unit 220-1 performs the autonomous and/or semi-autonomous driving maneuvers based on data collected by sensors 218. In some examples, autonomy unit 220-1 is operable to operate a fully autonomous system, a park-assist system, an advanced driver-assistance system (ADAS), and/or other autonomous system(s) for the vehicle.

Further, in the illustrated example, controller (or control module) 206 is operable to monitor an ambient environment of the vehicle. For example, to enable autonomy unit 220-1 to perform autonomous and/or semi-autonomous driving maneuvers, the controller collects data that is collected by sensors 218 of the vehicle. In some examples, the controller collects location-based data via communication module 216-1 and/or another module (e.g., a GPS receiver) to facilitate the autonomy unit in performing autonomous and/or semi-autonomous driving maneuvers. Additionally, the controller collects data from (i) adjacent vehicle(s) via communication module 216-1 and V2V communication and/or (ii) roadside unit(s) via communication module 216-1 and V2I communication to further facilitate autonomy unit 220-1 in performing autonomous and/or semi-autonomous driving maneuvers.

According to an embodiment, the communication module supports a communication protocol, wherein the communication protocol comprises at least one of an Advanced Message Queuing Protocol (AMQP), Message Queuing Telemetry Transport (MQTT) protocol, Simple (or Streaming) Text Oriented Message Protocol (STOMP), Zigbee protocol, Unified Diagnostic Services (UDS) protocol, Open Diagnostic eXchange format (ODX) protocol, Diagnostics Over Internet Protocol (DoIP), On-Board Diagnostics (OBD) protocol, and a predefined protocol standard.

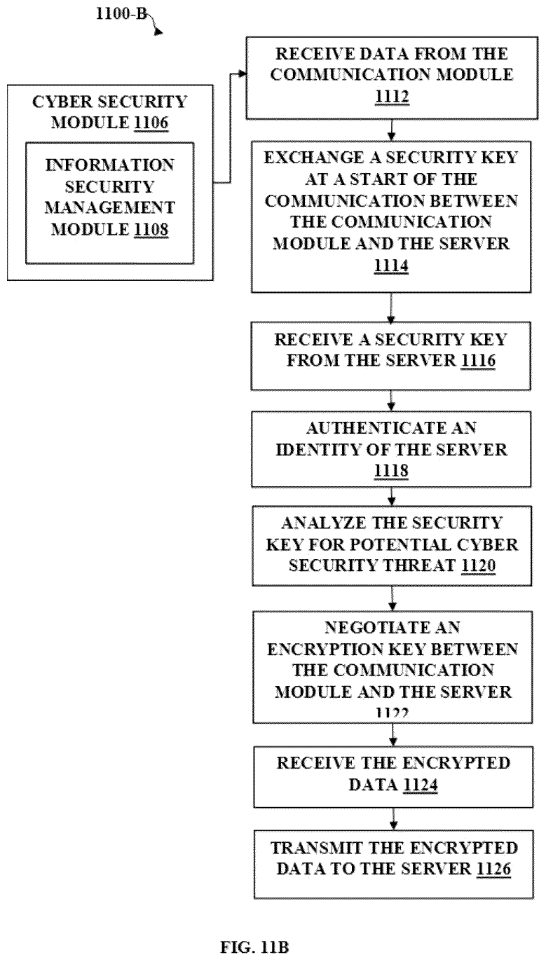

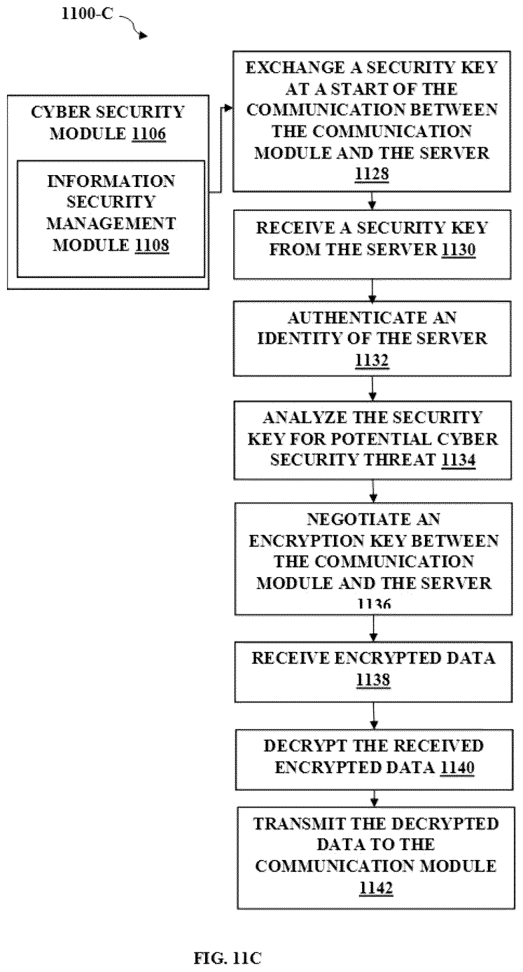

In an embodiment, communication module 216 may comprise cyber security module 1106 (shown in FIG. 11A). In some embodiments, communication module 216 may communicate with cyber security module 1106 to perform secure communication with nearby devices and external networks. In one aspect, a secure communication management (SCMT) computer device for providing secure data connections is provided. The SCMT computer device comprises a processor in communication with memory. The processor is programmed to receive, from a first device, a first data message. The first data message is in a standardized data format. The processor is also programmed to analyze the first data message for potential cyber security threats. If the determination is that the first data message does not contain a cyber security threat, the processor is further programmed to convert the first data message into a first data format associated with the vehicle environment and transmit the converted first data message to the vehicle system using a first communication protocol associated with the vehicle system. According to an embodiment, secure authentication for data transmissions comprises, provisioning a hardware-based security engine (HSE) located in communications system, said HSE having been manufactured in a secure environment and certified in said secure environment as part of an approved network; performing asynchronous authentication, validation and encryption of data using said HSE, storing user permissions data and connection status data in an access control list used to define allowable data communications paths of said approved network, enabling communications of the communications system with other computing system subjects to said access control list, performing asynchronous validation and encryption of data using security engine including identifying a user device (UD) that incorporates credentials embodied in hardware using a hardware-based module provisioned with one or more security aspects for securing the system, wherein security aspects comprising said hardware-based module communicating with a user of said user device and said HSE.

In some embodiments, communication module 216 may receive one or more information associated with the heat requirement in the thermal management system and communicate to the external server to obtain gate voltage values and external voltage values to generate the desired amount of heat.

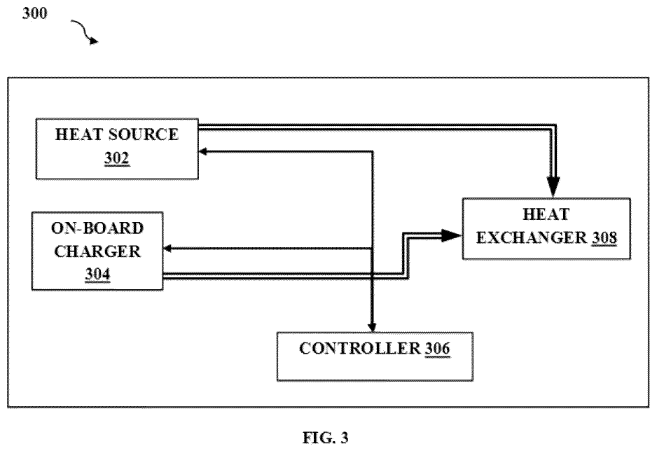

FIG. 3 illustrates block diagram 300 of a thermal management system in the vehicle according to an embodiment. In some embodiments, the thermal management system comprises a heating, ventilation, and air conditioning (HVAC) system.

Referring to FIG. 3, the thermal management system may comprise heat source 302, on-board charger (OBC) 304, controller 306, and heat exchanger 308. In some embodiments, heat source 302 comprises an electric motor associated with a traction inverter. The heat from the heat source may be used to heat the battery for optimal performance and/or to heat the vehicle cabin. In some embodiments, the heat from the heat source may be passed through a compressor to cool the energy thereby serving to cool the vehicle cabin.

Referring to FIG. 3, in some embodiments, controller 306 may obtain heat requirement of the thermal management system based on at least one of: ambient condition, on-going vehicle operations, anticipated vehicle operations, heat available in the thermal management system, and energy available in the vehicle for generating the required amount of heat and determine the amount of heat (i.e., additional heat) to be generated by the OBC based on the heat requirement. Further, the controller may control the OBC to generate the required additional heat. In some embodiments, one or more phase legs of the OBC may be configured as switches such that the power generated across the switch produces the required heat. The heat generated by heat source 302 and OBC 304 may be transferred to one or more components requiring the heat through heat exchanger 308. In some embodiments, the one or more components comprise at least one of Battery Management System (BMS), Engine Control Module (ECM), Powertrain Control Module (PCM), Transmission Control Module (TCM), Brake Control Module, Central Control Module (CCM), Central Timing Module (CTM), General Electronic Module (GEM), Body Control Module (BCM), and Suspension Control Module (SCM).

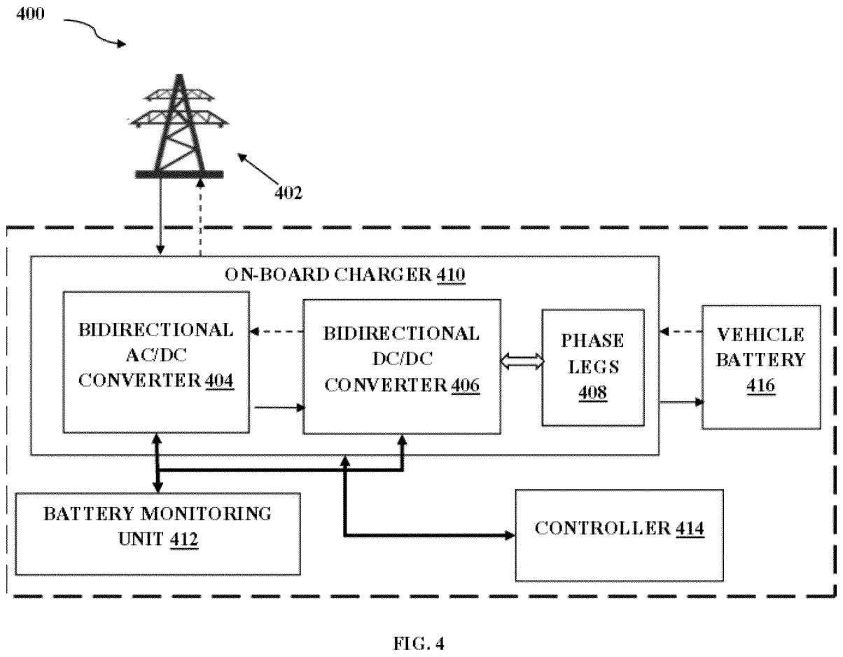

FIG. 4 illustrates functional block diagram 400 of the on-board charger in the vehicle according to an embodiment.

Referring to FIG. 4, on-board charger (OBC) 410 comprises bi-directional alternating current (AC) to direct current (DC) converter 404, bi-directional direct current to direct current (DC-DC) converter 406, and one or more phase legs 408. OBC 410 may be communicatively coupled with battery monitoring unit 412, controller 414, and vehicle battery 416. OBC 410 may operate in at least one of charging mode, discharging mode, or in a heat generation mode.

According to an embodiment, when OBC 410 is operated in charging mode or a discharging mode, OBC 410 is used for charging and discharging operations. The two bi-directional converters (404 and 406) enable both grid to vehicle (G2V) or energy source to vehicle communication, and vehicle to anything (V2X) communication. The charging and discharging operation of on-board charger 410 is controlled by one or more control signals from the battery monitoring unit 412. In an embodiment, battery monitoring unit 412 provides a control signal to enable G2V communication. The power from grid 402 is converted from AC to DC using bi-directional AC-DC converter 404, wherein the converted DC is stepped down using bi-directional DC-DC converter 406 for charging the vehicle battery. In another embodiment, battery monitoring unit 412 provides a control signal to enable V2X communication or discharge charge from the vehicle to the grid or energy source. The charge from the vehicle battery is up converted using bi-directional DC-DC converter 406, wherein the up converted DC signal is converted to AC using bi-directional AC-DC converter 404. In some embodiments, the processor sends control signals to the battery monitoring unit to control both the charging (e.g., G2V communication) and the discharging (e.g., V2X communication) operations.

Referring to FIG. 4, according to an embodiment, OBC (410) may operate in the heat generation mode. Controller 414 controls the operation of the OBC in the heat generation mode. In the heat generation mode, one or more phase legs 408 of the OBC are configured to operate as switches. Each of the switches is controlled to operate in an active region or linear region by controlling the gate voltage and the external voltage applied to the switches. According to an embodiment, controller 414 may control the gate voltage to the switches based on the amount of additional heat to be generated by the OBC. Further, the controller may control the operation of DC-DC converter 406 such that the output of the DC-DC converter provides the external voltage based on the amount of additional heat to be generated by the OBC. The switches are operated in the active region such that the amount of power across the switches provides the additional heat. The controller controls the gate voltage and external voltage such that the power across the switches or the heat generated by the OBC does not exceed the maximum heat limit of the OBC such that the required additional heat is generated without damaging the OBC.

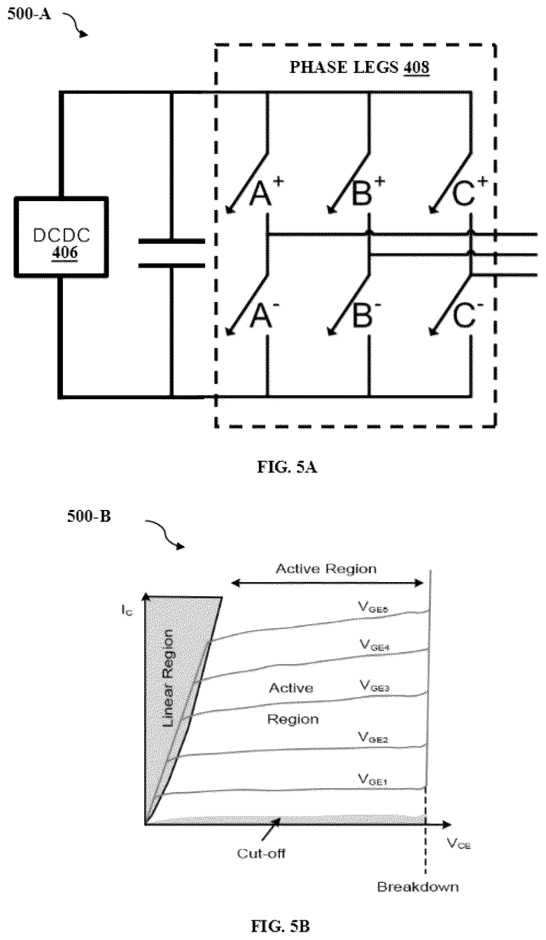

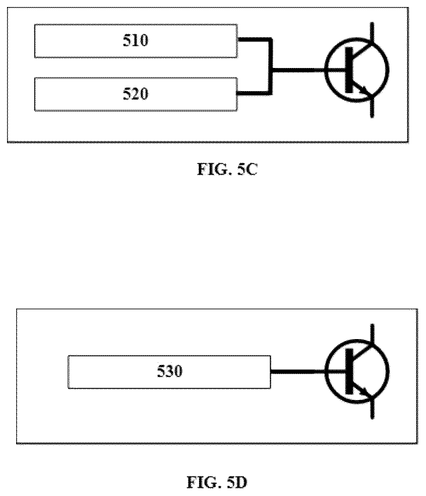

FIG. 5A illustrates circuit diagram 500-A of phase legs of the on-board charger according to an embodiment.

According to an embodiment, the OBC comprises three phase legs, wherein the three phase legs of the OBC are configured to consist of 6 switches namely A+, A−, B+, B−, C+, and C− as shown in FIG. 5A. All of these switches can be controlled as valves by applying a gate voltage. In some embodiments, the switches comprise at least one of transistor, field effect transistor (FET), metal oxide semiconductor field effect transistor (MOSFET), insulated gate MOSFET, complementary metal oxide semiconductor (CMOS), etc. By increasing the gate voltage (VGE) the switch can conduct more and more current for a given external voltage (VCE). Since electrical power is voltage across a device multiplied with the current through it, electrical power for the switches may be given as VCE*IC (Ic−current through the switch) which may be controlled by selecting the values of VGE and VCE. In some embodiments, when the OBC is operating in the power/heat generation mode, VGE required to generate the additional heat may be provided by gate driver circuits and VCE may be controlled by the DC-DC associated with the OBC.

In some embodiments, gate driver circuits may comprise different gate driver circuits connected in parallel with different outputs for the different operations, wherein at a particular time one gate driver circuit operates independent of the other. In some embodiments, gate driver circuits may comprise an active gate driver circuit.

Referring to FIG. 5A, DC-DC 406 may take power from the battery and be controlled by the controller to get the VCE required to generate the additional heat. In some embodiments, all six switches may be used to produce the additional heat. In such cases, the controller controls the switches to produce maximum heat without getting damaged. In some embodiments, the controller controls the DC-DC to set VCE and VGE for all the switches to produce the desired heat.

FIG. 5B illustrates voltage versus current graph 500-B according to an embodiment.

Referring to FIG. 5B, graph 500-B shows a cutoff region, a linear region, and an active region based on how the switches are operated. The switches as shown above in FIG. 5A may be controlled as valves by applying a gate voltage. In some embodiments, to generate additional heat, the switches are operated in the active region. By increasing the gate voltage (VGE1-5) the switches can conduct more and more current for a given external voltage (VCE).

FIGS. 5C and 5D illustrate different gate driver circuits according to an embodiment.

FIG. 5C illustrates a gate driver circuit for providing VGE according to an embodiment. Referring to FIG. 5C, the gate driver circuit comprises first gate driver circuit 510 for performing charging/discharging operation and second gate driver circuit 520 for heat generation. The first and second gate driver circuits produce different output voltages and operate independent of each other. Referring to FIG. 5A, for each of the switches the controller may select a gate voltage based on the relation between the gate voltage and device impedance associated with each of the switches. Further, the controller may select the gate voltage in relation to the high voltage applied to each of the switches, (i.e., the external voltage such as collector-emitter voltage or drain-source voltage depending on the type of switch). The high voltage is controlled by the DC-DC associated with the OBC.

FIG. 5D illustrates an active gate driver circuit for providing VGE according to an embodiment. Referring to FIG. 5D, active gate driver circuit 530 is operable to provide a variable or programmable output, thereby providing different gate voltages based on the operation to be performed i.e., whether the OBC is used for charging/discharging or heat generation. Further, the active gate driver may control the impedance of the switches and thereby provide a selection of an operation point for the switches. In some embodiments, the active gate driver circuit may comprise a pulse width modulation (PWM) technique based gate driver circuit. In some embodiments, the active gate driver circuit may comprise current source driver circuits.

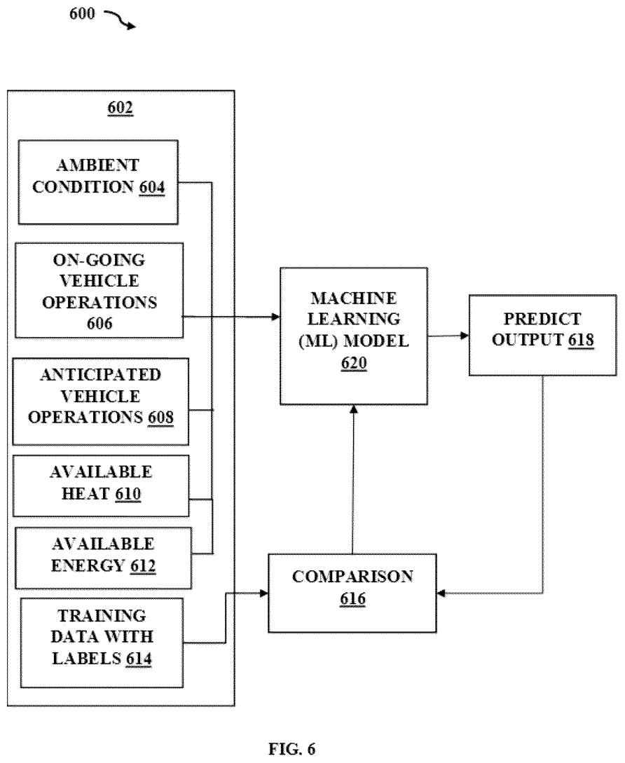

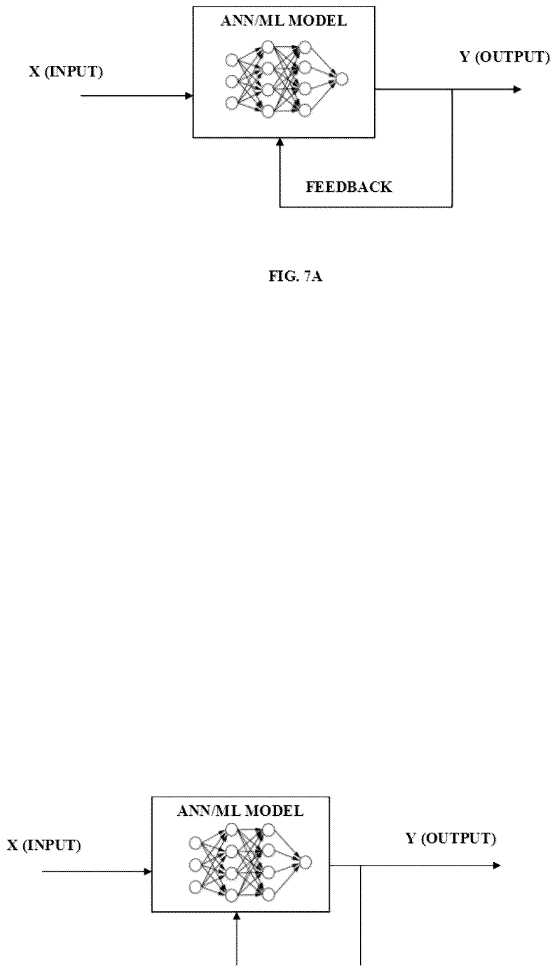

FIG. 6 illustrates an example block diagram for an Artificial Intelligence and Machine Learning (AI/ML) model used in a system for generating additional heat using an on-board charger according to an embodiment.

Referring to FIG. 6, the machine learning model 602 may take as input any data associated with ambient condition 604, on-going vehicle operations 606, anticipated vehicle operations 608, available heat 610 i.e., the heat available in the thermal management system, and available energy 612 i.e., energy available in the vehicle for generating the required amount of heat, and learn (machine learning model 620) to identify features within the data that are predictive of the gate voltage values and external voltage values to enable the OBC to generate the required additional heat. Training data with labels 614 may comprise, for example, historical data of gate voltages and external voltages associated with different amounts of generated heat.

In an embodiment, during training, machine learning model 620 may process the training data sample (e.g., ambient condition 604, on-going vehicle operations 606, anticipated vehicle operations 608, available heat 610, and available energy 612), and, based on the current parameters of machine learning model 620, predict output 618 which may be an additional amount of heat required in the vehicle. In an embodiment, the real-time sensor data may be processed using one or more machine learning models 620, trained based on similar types of data to correctly select the gate voltage and external voltage values. For example, comparison at 616 may be based on a loss function that measures a difference between the predicted/detected output and training data with labels 618. Based on the comparison at 616 or the corresponding output of the loss function, a training algorithm may update the parameters of machine learning model 620 with the objective of minimizing the differences or loss between subsequent predicted output 618 and corresponding labels 614. By iteratively training in this manner, machine learning model 620 may “learn” from the different training data samples and become better at predicting output 618. In an embodiment, machine learning model 620 is trained using data which is specific to an OBC and a vehicle model at different situations for predicting various values of gate voltage and external voltage.

Through training, machine learning model 620 may learn to identify predictive and non-predictive features and apply the appropriate weights to the features to optimize detecting and predictive accuracy of machine learning model 620. In embodiments where supervised learning is used and each training data sample has a label, the training algorithm may iteratively process each training data sample and generate a predicted output 618. Any suitable machine learning model and training algorithm may be used, including, e.g., neural networks, decision trees, clustering algorithms, and any other suitable machine learning techniques. Once trained, machine learning model 620 may take input data and predict the amount of heat to be generated by the OBC. In an embodiment, machine learning model 620 is an artificial neural networks (ANN) model.

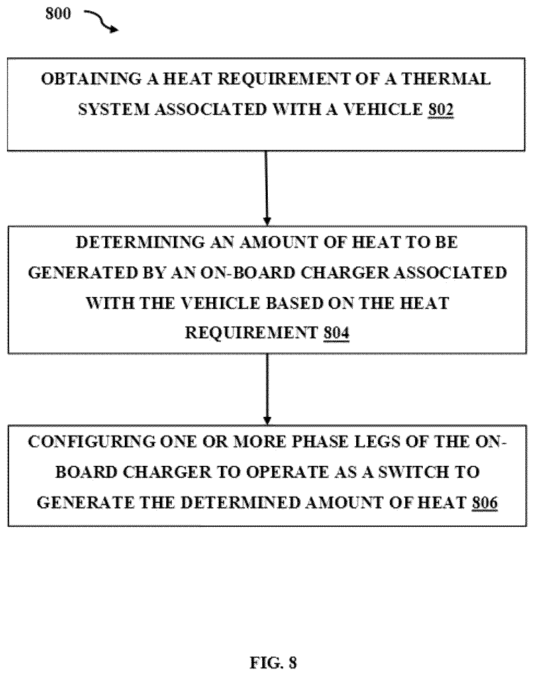

FIG. 7A shows a structure of the neural network/machine learning model with a feedback loop according to an embodiment. Artificial neural networks (ANNs) model comprises an input layer, one or more hidden layers, and an output layer. Each node, or artificial neuron, connects to another and has an associated weight and threshold. If the output of any individual node is above the specified threshold value, that node is activated, sending data to the next layer of the network. Otherwise, no data is passed to the next layer of the network. A machine learning model or an ANN model may be trained on a set of data to take a request in the form of input data, make a prediction on that input data, and then provide a response. Input data comprises data associated with ambient condition 604, on-going vehicle operations 606, anticipated vehicle operations 608, available heat 610, and available energy 612, to predict the amount of heat to be generated by the OBC, and to provide the gate voltage value and external voltage value to be applied to the OBC. The model may learn from the data. Learning can be supervised learning and/or unsupervised learning and may be based on different scenarios and with different datasets. Supervised learning comprises logic using at least one of a decision tree, logistic regression, and support vector machines. Unsupervised learning comprises logic using at least one of a k-means clustering, a hierarchical clustering, a hidden Markov model, and an a priori algorithm.

In an embodiment, ANNs may be a Deep-Neural Network (DNN), which is a multilayer tandem neural network comprising Artificial Neural Networks (ANN), Convolution Neural Networks (CNN) and Recurrent Neural Networks (RNN) that can recognize features from inputs, do an expert review, and perform actions that require predictions, creative thinking, and analytics. In an embodiment, ANNs may be Recurrent Neural Network (RNN), which is a type of Artificial Neural Networks (ANN), which uses sequential data or time series data. Deep learning algorithms are commonly used for ordinal or temporal problems, such as language translation, Natural Language Processing (NLP), speech recognition, image recognition, etc. Like feedforward and convolutional neural networks (CNNs), recurrent neural networks utilize training data to learn. They are distinguished by their “memory” as they take information from prior input via a feedback loop to influence the current input and output. An output from the output layer in a neural network model is fed back to the model through the feedback. The variations of weights in the hidden layer(s) will be adjusted to fit the expected outputs better while training the model. This will allow the model to provide results with far fewer mistakes. The neural network is featured with the feedback loop to adjust the system output dynamically as it learns from the new data. In machine backpropagation, propagation and feedback loops are used to train an Artificial Intelligence (AI) model and continuously improve it upon usage. As the incoming data that the model receives increases, there are more opportunities for the model to learn from the data. The feedback loops, or backpropagation algorithms, identify inconsistencies and feed the corrected information back into the model as an input. Even though the AI/ML model is trained well, with large sets of labeled data and concepts, after a while the model's performance may decline while adding new, unlabeled input due to many reasons which include, but not limited to, concept drift, recall precision degradation due to drifting away from true positives, and data drift over time. A feedback loop to the model keeps the AI results accurate and ensures that the model maintains its performance and improvement, even when new unlabeled data is assimilated. A feedback loop refers to the process by which an AI model's predicted output is reused to train new versions of the model.

Initially, when the AI/ML model is trained, a few labeled samples comprising both positive and negative examples of the concepts (e.g., different types of objects, different users interacting with different objects, tracking frequency, monitoring frequency etc.) are used that are meant for the model to learn how and what adjustments need to be performed. Afterward, the model is tested using unlabeled data. By using, for example, deep learning and neural networks, the model can then make predictions on whether the desired output (for e.g., recognition of objects and the corresponding confidence score, dynamic tracking of the object and recording last known position, a prediction of objects that the user might likely be forgetting, and the locations within the vehicle where objects when placed may be likely forgotten etc.) is in the predicted accuracy level. However, in cases where the model returns a low probability score, this input may be sent to a controller (maybe a human moderator) which verifies and, as necessary, corrects the result. The human moderator may be used only in exceptional cases. The feedback loop feeds labeled data, auto-labeled or controller-verified, back to the model dynamically and is used as training data so that the system can improve its predictions in real-time and dynamically. These models may be utilized at various levels, for example, prediction of the additional amount of heat to be generated by the OBC.

FIG. 7B shows the structure of the neural network/machine learning model with reinforcement learning according to an embodiment. The network receives feedback from authorized networked environments. Though the feedback logic is similar to supervised learning, the feedback obtained in this case is evaluative, not instructive, which means there is no teacher as in supervised learning. After receiving feedback, the network performs adjustments of the weights to get better predictions in the future. Machine learning techniques, like deep learning, allow models to take labeled training data and learn to recognize those concepts in subsequent data and images. The model may be fed with new data for testing, hence by feeding the model with data it has already predicted over, the training gets reinforced. If the machine learning model has a feedback loop, the learning is further reinforced with a reward for each true positive of the output of the system. Feedback loops ensure that AI results do not stagnate. By incorporating a feedback loop, the model output keeps improving dynamically and over usage/time.

In an embodiment, the machine learning model is configured to learn using labeled data using a supervised learning method, wherein the supervised learning method comprises logic using at least one of a decision tree, a logistic regression, a support vector machine, a k-nearest neighbors, a Naïve Bayes, a random forest, a linear regression, a polynomial regression, and a support vector machine for regression.

In an embodiment, the machine learning model is configured to learn from the real-time data using an unsupervised learning method, wherein the unsupervised learning method comprises logic using at least one of a k-means clustering, a hierarchical clustering, a hidden Markov model, and an a priori algorithm.

In an embodiment, the machine learning model has a feedback loop, wherein the output from a previous step is fed back to the model in real-time to improve the performance and accuracy of the output of a next step.

In an embodiment, the machine learning model comprises a recurrent neural network model.

In an embodiment, the machine learning model has a feedback loop, wherein the learning is further reinforced with a reward for each true positive of the output of the system.

FIG. 8 illustrates a flow chart describing a method of generating additional heat using an on-board charger according to an embodiment.

Referring to FIG. 8, method 800 comprises, obtaining a heat requirement of a thermal system associated with a vehicle 802. Further, method 800 comprises determining an amount of heat to be generated by an on-board charger associated with the vehicle based on the heat requirement 804 and configuring one or more phase legs of the on-board charger to operate as a switch to generate the determined amount of heat 806, wherein the heat requirement of the thermal management system is based on at least one of: ambient condition, on-going vehicle operations, anticipated vehicle operations, heat available in the thermal management system, and energy available in the vehicle for generating the required amount of heat.

In some embodiments, method 800 further comprises controlling each of the switches associated with the one or more phase legs to generate the determined amount of heat.

In some embodiments, method 800 further comprises controlling each of the switches associated with the one or more phase legs based on a voltage applied at a gate terminal of each of the switches and an external voltage, wherein each of the switches is controlled to operate in an active region to generate the determined amount of heat, wherein the voltage applied at the gate terminal is determined based on the amount of heat to be generated by the on-board charger and the external voltage is set based on the amount of heat to be generated by the on-board charger.

In some embodiments, the external voltage is set based on controlling a direct current to direct current (DC-DC) converter.

In some embodiments, method 800 further comprises: configuring at least three phase legs of the on-board charger to operate as six switches; and operating the six switches in the active region.

In some embodiments, method 800 further comprises: determining a status of the vehicle; and configuring the one or more phase legs to operate as a switch based on the status of the vehicle.

In some embodiments, the status of the vehicle comprises at least one of a charging status, a discharging status, and a DC fast charging status.

In some embodiments, method 800 further comprises: distributing the heat generated by the on-board charger to one or more components in the vehicle based on the thermal requirement associated with the one or more components in the vehicle.

In some embodiments, method 800 further comprises: determining a maximum heat level associated with the on-board charger; and controlling the amount of heat to be generated by the on-board charger based on the maximum heat level.

In some embodiments, the amount of heat to be generated by the on-board charger is less than the maximum heat level.

In some embodiments, method 800 further comprises: determining the amount of heat to be generated by the on-board charger associated with the vehicle based on the heat requirement of the thermal management system and the maximum heat level.

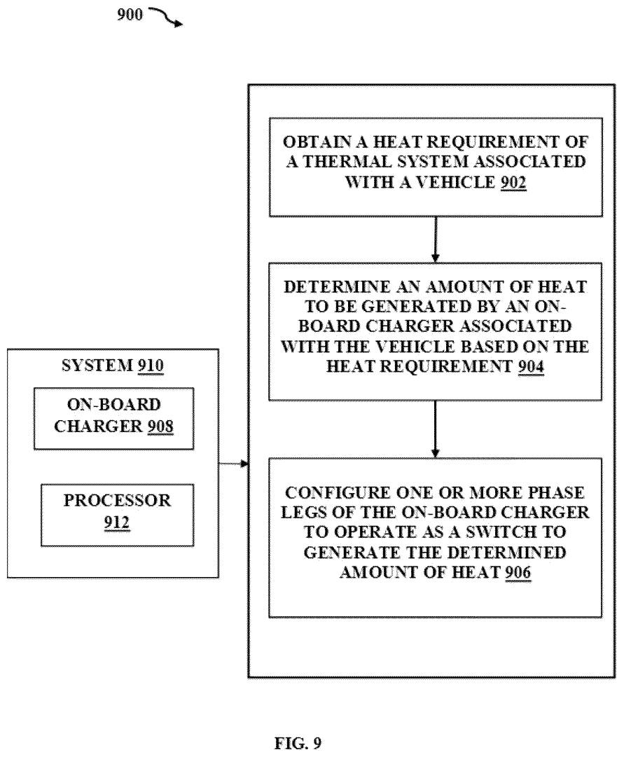

FIG. 9 illustrates block diagram 900 of the system implementing the method for generating additional heat using an on-board charger according to an embodiment.

According to an embodiment, disclosed is system 910 comprising processor 912 operatively coupled to an on-board charger (OBC) 908, wherein processor 912 is operable to: obtain a heat requirement of a thermal system associated with a vehicle at step 902, determine an amount of heat to be generated by an on-board charger associated with the vehicle based on the heat requirement at step 904, and configure one or more phase legs of the on-board charger to operate as a switch to generate the determined amount of heat at step 906, wherein the heat requirement of the thermal management system is based on at least one of: ambient condition, on-going vehicle operations, anticipated vehicle operations, heat available in the thermal management system, and energy available in the vehicle for generating the required amount of heat.

In some embodiments, processor 912 is further operable to: obtain heat requirement of a thermal management system associated with the vehicle; and determine the amount of heat to be generated by the on-board charger based on the heat requirement.

In some embodiments, processor 912 is further operable to: control each of the switches associated with the one or more phase legs based on a voltage applied at a gate terminal of each of the switches and an external voltage.

In some embodiments, processor 912 is further operable to: distribute the heat generated by the on-board charger to the one or more components in the vehicle based on the thermal requirement associated with the one or more components in the vehicle.

According to an embodiment, the heat generated by the on-board charger is distributed equally to the one or more components in the vehicle.

According to an embodiment, the heat generated by the on-board charger is distributed at different ratios to the one or more components in the vehicle.

In some embodiments, processor 912 is further operable to: determine a status of the vehicle; and configure the one or more phase legs to operate as a switch based on the status of the vehicle.

According to an embodiment, the status of the vehicle comprises at least one of a charging status, a discharging status, and DC fast charging status.

In some embodiments, processor 912 is further operable to: determine a maximum heat level associated with the on-board charger; and control the amount of heat to be generated by the on-board charger based on the maximum heat level, wherein the amount of heat to be generated by the on-board charger is less than the maximum heat level.

According to an embodiment, system 910 is associated with at least one of: the vehicle, an external server, a cloud server, a centralized server associated with a manufacturer of the vehicle, and a third-party server authorized by the manufacturer of the vehicle.

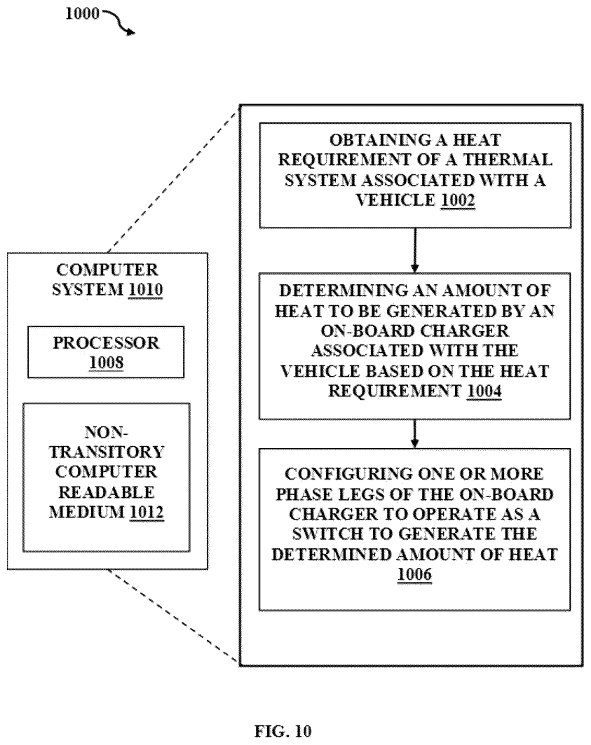

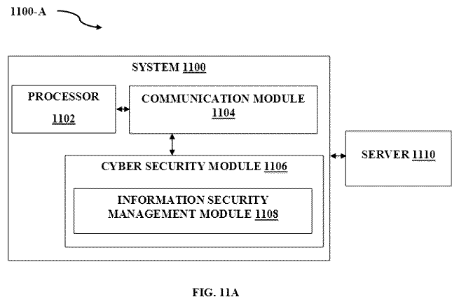

FIG. 10 illustrates a block diagram 1000 of the method executed by the non-transitory computer-readable medium for generating additional heat using an on-board charger according to an embodiment.

According to an embodiment, disclosed is computer system 1010 non-transitory computer-readable medium 1012 having stored thereon instructions executable by processor 1008 to perform operations comprising: obtaining a heat requirement of a thermal system associated with a vehicle at step 1002, determining an amount of heat to be generated by an on-board charger associated with the vehicle based on the heat requirement at step 1004, and configure one or more phase legs of the on-board charger to operate as a switch to generate the determined amount of heat at step 1006, wherein the heat requirement of the thermal management system is based on at least one of: ambient condition, on-going vehicle operations, anticipated vehicle operations, heat available in the thermal management system, and energy available in the vehicle for generating the required amount of heat.

In some embodiments, non-transitory computer-readable medium 1012 further comprises instructions to perform operations comprising: controlling each of the switches associated with the one or more phase legs to generate the determined amount of heat.

In some embodiments, non-transitory computer-readable medium 1012 further comprises instructions to perform operations comprising: controlling each of the switches associated with the one or more phase legs based on a voltage applied at a gate terminal of each of the switches and an external voltage, wherein each of the switches is controlled to operate in an active region to generate the determined amount of heat.

In some embodiments, non-transitory computer-readable medium 1012 further comprises instructions to perform operations comprising: determining a status of the vehicle; and configuring the one or more phase legs to operate as a switch based on the status of the vehicle, wherein the status of the vehicle comprises at least one of a charging status, a discharging status, and a DC fast charging status.

In some embodiments, non-transitory computer-readable medium 1012 further comprises instructions to perform operations comprising: distributing the heat generated by the on-board charger to the one or more components in the vehicle based on the thermal requirement associated with one or more components in the vehicle.

In some embodiments, non-transitory computer-readable medium 1012 further comprises instructions to perform operations comprising: determining a maximum heat level associated with the on-board charger; and controlling the amount of heat to be generated by the on-board charger based on the maximum heat level.

In some embodiments, non-transitory computer-readable medium 1012 further comprises instructions to perform operations comprising: determining the amount of heat to be generated by the on-board charger associated with the vehicle based on the heat requirement of the thermal management system and the maximum heat level, wherein the amount of heat to be generated by the on-board charger is less than the maximum heat level.

FIG. 11A shows block diagram 1100-A of a cyber security module in view of the system and server according to an embodiment.

Referring to FIG. 11A, system 1100 comprising processor 1102, communication module 1104, cyber security module 1106, and information security management module 1108 in communication with server 1110, is shown. The communication of data between system 1100 and server 1110 through communication module 1104 is first verified by information security management module 1108 before being transmitted from system 1100 to server 1110 or from server 1110 to system 1100. Information security management module 1108 is operable to analyze the data for potential cyber security threats, to encrypt the data when no cyber security threat is detected, and to transmit the data encrypted to system 1100 or server 1110.

FIG. 11B shows an embodiment of the cyber security module, in accordance with some embodiments of the present disclosure.

Referring to FIG. 11B, method 1100-B for securing the data through cyber security module 1106 is shown. At step 1112, the information security management module is operable to receive data from the communication module. At step 1114, the information security management module exchanges a security key at a start of the communication between the communication module and the server. At step 1116, the information security management module receives a security key from the server. At step 1118, the information security management module authenticates an identity of the server by verifying the security key. At step 1120, the information security management module analyzes the security key for potential cyber security threats. At step 1122, the information security management module negotiates an encryption key between the communication module and the server. At step 1124, the information security management module receives the encrypted data. At step 1126, the information security management module transmits the encrypted data to the server when no cyber security threat is detected.

FIG. 11C shows another embodiment of the cyber security module, in accordance with some embodiments of the present disclosure.

Referring to FIG. 11C, method 1100-C for securing the data through the cyber security module is shown. At step 1128, the information security management module is operable to: exchange a security key at a start of the communication between the communication module and the server. At step 1130, the information security management module receives a security key from the server. At step 1132, the information security management module authenticates an identity of the server by verifying the security key. At step 1134, the information security management module analyzes the security key for potential cyber security threats. At step 1136, the information security management module negotiates an encryption key between the communication module and the server. At step 1138, the information security management module receives encrypted data. At step 1140, information security management module 1108 decrypts the encrypted data, and performs an integrity check of the decrypted data. At step 1142, information security management module 1108 transmits the decrypted data to the communication module when no cyber security threat is detected.

In an embodiment, the integrity check is a hash-signature verification using a Secure Hash Algorithm 256 (SHA256) or a similar method. In an embodiment, the information security management module is configured to perform asynchronous authentication and validation of the communication between the communication module and the server. In an embodiment, the information security management module is configured to raise an alarm if a cyber security threat is detected. In an embodiment, the information security management module is configured to discard the encrypted data received if the integrity check of the encrypted data fails. In an embodiment, the information security management module is configured to check the integrity of the decrypted data by checking accuracy, consistency, and any possible data loss during the communication through the communication module.

In an embodiment, the server is physically isolated from the system through the information security management module. When the system communicates with the server as shown in FIG. 11A, identity authentication is first carried out on the system and then on the server. The system is responsible for communicating/exchanging a public-key of the system and a signature of the public-key with the server. The public-key of the system and the signature of the public-key are sent to the information security management module. The information security management module decrypts the signature and verifies whether the decrypted public-key is consistent with the received original public-key or not. If the decrypted public-key is verified, the identity authentication is passed. Similarly, the system and the server carry out identity authentication on the information security management module. After the identity authentication is passed on to the information security management module, the two communication parties, the system, and the server, negotiate an encryption key and an integrity check key for data communication of the two communication parties through the authenticated asymmetric key. A session ID number is transmitted in the identity authentication process, so that the key needs to be bound with the session ID number; when the system sends data to the outside, the information security gateway receives the data through the communication module, performs integrity authentication on the data, then encrypts the data through a negotiated secret key, and finally transmits the data to the server through the communication module. When the information security management module receives data through the communication module, the data is decrypted first, integrity verification is carried out on the data after decryption, and if verification is passed, the data is sent out through the communication module; otherwise, the data is discarded.

In an embodiment, the identity authentication is realized by adopting an asymmetric key with a signature. In an embodiment, the signature is realized by a pair of asymmetric keys which are trusted by the information security management module and the system, wherein the private key is used for signing the identities of the two communication parties, and the public-key is used for verifying that the identities of the two communication parties are signed. Signing identity comprises a public and a private key pair. In other words, signing identity is referred to as the common name of the certificates which are installed in the user's machine. In an embodiment, both communication parties need to authenticate their own identities through a pair of asymmetric keys, and a task in charge of communication with the information security management module of the system is identified by a unique pair of asymmetric keys. In an embodiment, the dynamic negotiation key is encrypted by adopting a Rivest-Shamir-Adleman (RSA) encryption algorithm. RSA is a public-key cryptosystem that is widely used for secure data transmission. The negotiated keys include a data encryption key and a data integrity check key. In an embodiment, the data encryption method is a Triple Data Encryption Algorithm (3DES) encryption algorithm. The integrity check algorithm is a Hash-based Message Authentication Code (HMAC-MD5-128) algorithm. When data is output, the integrity check calculation is carried out on the data, the calculated Message Authentication Code (MAC) value is added with the header of the value data message, then the data (including the MAC of the header) is encrypted by using a 3DES algorithm, the header information of a security layer is added after the data is encrypted, and then the data is sent to the next layer for processing. In an embodiment the next layer refers to a transport layer in the Transmission Control Protocol/Internet Protocol (TCP/IP) model.

The information security management module ensures the safety, reliability, and confidentiality of the communication between the system and the server through the identity authentication when the communication between the two communication parties starts the data encryption and the data integrity authentication. The method is particularly suitable for an embedded platform which has less resources and is not connected with a Public-key Infrastructure (PKI) system and can ensure that the safety of the data on the server cannot be compromised by a hacker attack under the condition of the Internet by ensuring the safety and reliability of the communication between the system and the server.

In some embodiments, system 100 of FIG. 1 associated with the vehicle may exchange information associated with the heat requirement of the thermal management system with an external server. The external server may process the information and provide a range of gate voltages and external control voltages to be used with the OBC switches such that they operate in the linear region and generate the required amount of heat. The communication module associated with the vehicle may be coupled to the information security management module. Heat requirement information may be sent to the external server through the communication module. Heat requirement information may be verified by the information security management module before being transmitted from the vehicle to the external server. The information security management module is operable to analyze the data for potential cyber security threats, to encrypt the data when no cyber security threat is detected, and to transmit the data encrypted to the external server.

Other specific forms may embody the present disclosure without departing from its spirit or characteristics. The embodiments described are in all respects illustrative and not restrictive. Therefore, the appended claims rather than the description herein indicate the scope of the disclosure. All variations which come within the meaning and range of equivalency of the claims are within their scope.

1-45. (canceled)

46. A system comprising:
an on-board charger; and
a processor operatively coupled to the on-board charger, wherein the processor is operable to:
determine an amount of heat to be generated by the on-board charger, wherein the on-board charger is associated with a vehicle;
configure one or more phase legs of the on-board charger to operate as a switch; and
control each of the switches associated with the one or more phase legs to generate the determined amount of heat.

47. The system of claim 46, wherein the processor is further operable to:
obtain heat requirement of a thermal management system associated with the vehicle; and
determine the amount of heat to be generated by the on-board charger based on the heat requirement.

48. The system of claim 47, wherein the heat requirement of the thermal management system is based on at least one of: ambient condition, on-going vehicle operations, anticipated vehicle operations, heat available in the thermal management system, and energy available in the vehicle for generating the determined amount of heat.

49. The system of claim 48, wherein the ambient condition comprises at least one of temperature outside the vehicle and cabin temperature of the vehicle.

50. The system of claim 48, wherein the on-going vehicle operations comprises current operation status of one or more components in the vehicle and the anticipated vehicle operations comprises an operation status of the one or more components in the vehicle at a predefined time.

51. The system of claim 50, wherein the one or more components comprises at least one of: Battery Management System (BMS), Engine Control Module (ECM), Powertrain Control Module (PCM), Transmission Control Module (TCM), Brake Control Module, Central Control Module (CCM), Central Timing Module (CTM), General Electronic Module (GEM), Body Control Module (BCM), and Suspension Control Module (SCM).

52. The system of claim 46, wherein the processor is further operable to:
control each of the switches associated with the one or more phase legs based on a voltage applied at a gate terminal of each of the switches and an external voltage.

53. The system of claim 52, wherein each of the switches is controlled to operate in an active region to generate the determined amount of heat.

54. The system of claim 52, wherein the voltage applied at the gate terminal is determined based on the amount of heat to be generated by the on-board charger and the external voltage is set based on the amount of heat to be generated by the on-board charger.

55. The system of claim 54, wherein the external voltage is set based on controlling a direct current to direct current (DC-DC) converter.

56. The system of claim 53, wherein the on-board charger comprises three phase legs, wherein the three phase legs of the on-board charger are configured to operate as six switches, and wherein the six switches operate in the active region.

57. The system of claim 50, wherein the processor is further operable to:
distribute the heat generated by the on-board charger to the one or more components in the vehicle based on a thermal requirement associated with the one or more components in the vehicle.

58. The system of claim 57, wherein the heat generated by the on-board charger is distributed at least one of: equally to the one or more components in the vehicle and at different ratios to the one or more components in the vehicle.

59. A method comprising:
obtaining a heat requirement of a thermal management system associated with a vehicle;
determining an amount of heat to be generated by an on-board charger based on the heat requirement, wherein the on-board charger is associated with the vehicle; and
configuring one or more phase legs of the on-board charger to operate as a switch to generate the determined amount of heat.

60. The method of claim 59 further comprising:
determining a status of the vehicle; and
configuring the one or more phase legs to operate as the switch based on the status of the vehicle.

61. The method of claim 60, wherein the status of the vehicle comprises at least one of a charging status, a discharging status, and a direct current (DC) fast charging status.

62. The method of claim 59 further comprising:
determining a maximum heat level associated with the on-board charger; and
controlling the amount of heat to be generated by the on-board charger based on the maximum heat level.

63. The method of claim 62, wherein the amount of heat to be generated by the on-board charger is less than the maximum heat level.

64. The method of claim 63 further comprising:
determining the amount of heat to be generated by the on-board charger based on the heat requirement of the thermal management system and the maximum heat level.

65. A non-transitory computer-readable medium having stored thereon instructions executable by a processor to perform operations comprising:
obtaining a heat requirement of a thermal management system associated with a vehicle;
determining an amount of heat to be generated by an on-board charger based on the heat requirement, wherein the on-board charger is associated with the vehicle; and
configuring one or more phase legs of the on-board charger to operate as a switch to generate the determined amount of heat.
